(19) United States
(12) Patent Application Publication
(10) Pub. No.: US 2006/0125616 A1
(43) Pub. Date: Jun. 15, 2006

(54) Method for a changing safety signaling system

(76) Inventor: Won Moo Song, Haltom City, TX (US)

Correspondence Address: CARSTENS & CAHOON, LLP, P O BOX 802334, DALLAS, TX, 75380, US

(21) Appl. No.: 11/180,431

(22) Filed: Jul. 13, 2005

Related U.S. Application Data
(63) Continuation-in-part of application No. 11/057,970, filed on Feb. 15, 2005.
(63) Continuation-in-part of application No. 10/999,443, filed on Nov. 29, 2004.

(51) Int. Cl. B60Q 1/22; B60Q 1/26; B60Q 1/52

(52) U.S. Cl. 340/463; 340/468; 340/471; 340/469

(57) ABSTRACT

The present invention provides a method for a changing safety signaling system. The safety signaling system can change as a result of changing driving conditions that stem from changes in the weather or changes in vehicle velocity. As a vehicle brakes, coasts, turns, or accelerates, front-facing, side-facing, top-facing, and/or rear facing indicators can communicate vehicular acceleration, coasting, and braking to a pedestrian or other vehicles. A distance sensor can be used to trigger a signal to alert a second vehicle that the first vehicle is braking hard and slowing fast or can be used to warn the operator of the first car that a collision may be imminent and can be used to warn the operator of a second car that measures can be taken to avoid a collision or minimize damage from a collision. The instant invention can be utilized by either a first car or a second car.

### CROSS REFERENCE TO RELATED APPLICATION

This application is a continuation-in-part of U.S. application Ser. No. 10/999,443 entitled “Improved Vehicle Accelerator and Brake Indicators” and filed on Nov. 29, 2004, and a continuation-in-part of U.S. application Ser. No. 11/057,970, entitled “System for Improving the Visibility of a Vehicle During Reduced Visibility Conditions”, filed on Feb. 15, 2005.

### BACKGROUND

1. Technical Field

This invention relates generally to the field of safety signal indicator systems installed on a vehicle, and more particularly to a method for changing the safety signaling system based on changing driving conditions.

2. Background of the Invention

Operating lights are used on all types of vehicles including, but not limited to, aircraft, cars, motorcycles, trucks, trains, bicycles, and toy vehicles. Brake lights of currently produced vehicles are typically red and are usually found only on the rear of a vehicle. Many vehicles also have red on the rear, yellow, orange or amber running lights on the front or rear. Such running lights are also on the front corners or sides of a vehicle. The intent of such lights is to provide higher visibility for vehicles.

FIG. 1 illustrates the placement of rear facing lights on a typical motor vehicle according to the prior art. The description of the present invention refers to an automobile, but those having ordinary skill in the art will appreciate that the invention may be adapted to other types of vehicles without departing from the invention. With reference to FIG. 1, red running lights and brake lights 205 are typically the largest and most prominent lights on the rear of a vehicle. Brake lights of currently produced vehicles are typically red and are usually found only on the rear of a vehicle. Brake lights present brightly lit red lights while running lights generally present dimly lit red lights to observers. Many vehicles also have yellow, orange or amber running lights 201 visible from the front and rear of a vehicle. Such lights may also be used as turn signal indicators, or may work exclusively as turn signal indicators. Nearly all vehicles also have a white reverse drive indicator light 208, and many have an additional centrally located brake indicator light 206 mounted inside the vehicle's rear window.

Many states allow for the addition of other rearward facing lights excepting to white lights. It is a common practice for individuals to install purple, blue, green or other color of ornamental running lights. Such ornamental running lights may be attached and displayed under, on the sides, or on a particular accessory of a vehicle.

On the rear of a vehicle, red vehicle brake lights are more brightly lit than red running lights. Brake lights provide a visual indication to following drivers that a vehicle's brakes have been engaged. Lights on the front of a vehicle are generally limited to headlights, marker or running lights, and turn signal lights. There are no indicators of the use of a vehicle's brakes or accelerator. Further, there is no indication of the intensity with which the brakes are being applied.

FIG. 2 shows a front oblique perspective view of a prior art motor vehicle. Headlights are generally white and have either a clear or white translucent protective lens covering an electric light emitting bulb. With reference to FIG. 2, one or more forward facing headlights 104 are mounted near each corner of a vehicle. One or more yellow, orange or amber running lights 102 are also mounted near each corner. Some vehicles also have optional running or fog lights 106 mounted under the bumper of the vehicle. Some vehicles also have side mounted running lights.

One problem exists when a following vehicle operator does not know whether the preceding operators of vehicles are using the vehicle's accelerator, or are coasting wherein the operator is using neither the accelerator nor brake. An additional problem exists in that a following vehicle operator does not know how hard the preceding operators of vehicles are applying the brakes.

Further, there are substantial risks associated with driving automobiles and other vehicles at relatively high rates of speed under hazardous weather conditions such as fog. Traditional operating lighting on vehicles provides some warning to other drivers of the proximity of the vehicle. Such operating lights are used on all types of vehicles including, but not limited to, aircraft, cars, motorcycles, trucks, trains, bicycles, and toy vehicles. These lights are for general purpose use, and are mainly for communicating to other drivers the position and intention of the vehicle operator, and for illuminating objects for the safe operation of the vehicle under normal, rather than hazardous, conditions.

Another problem exists wherein observers and operators of other vehicles who are positioned in front of a vehicle do not know whether the operator of the vehicle has engaged its brake system. For example, a pedestrian crossing a street would know when an operator of a passing vehicle has applied his brakes in response to an obstacle in the operator's path. In another example, observers at an intersection would be able to determine if approaching vehicles have engaged their brakes. Sometimes it is difficult to judge whether the driver of an approaching vehicle intends to continue through a yellow semaphore light.

In 2003, the National Highway Traffic Safety Administration reported that in 2003, 4,749 pedestrians were killed in crashes with motor vehicles, and over 70,000 were injured. With a forward-facing brake light and accelerator light, many pedestrians can better use their own judgment before crossing the path of a vehicle. Currently, a pedestrian has few external indicators about the reaction or behavior of an oncoming vehicle operator other than a rough visual estimate of deceleration.

Another problem exists when a vehicle operator of a following vehicle does not know whether the operators of preceding vehicles are using the vehicle's accelerator, or are coasting wherein the operator is using neither the accelerator nor brake. Such information would be vital to know while driving under hazardous weather conditions. In 2003, 42,643 people were killed in the estimated 6,328,000 police-reported motor vehicle traffic crashes, and 2,889,000 people were injured. Providing faster and improved information regarding the operation of other vehicles in the path of a moving vehicle would substantially contribute to the safe operation of motor vehicles.

A number of patents have issued in an attempt to meet the need for improved accelerator and brake indicators.

U.S. Pat. No. 6,663,271, issued to Giglio on Dec. 16, 2003, discloses a motor vehicle which has left and right front pillars having a brake light mounted in a recess so as to be visible from 360 degrees. However, such a brake light does not communicate the state of the acceleration pedal of a vehicle.

U.S. Pat. No. 5,798,691, issued to Kao on Aug. 25, 1998, discloses an accessory brake light system for the front of an automobile consisting of a plurality of LEDs mounted in an elongated housing. By flashing in different sequences, the LEDs can provide various warning signals to indicate braking conditions of the automobile, such as whether the vehicle is fully stopped, slowing down, or accelerating. Such a system is not visible from the rear of a vehicle.

U.S. Pat. No. 5,680,101 discloses a third rearward facing brake light. However, the placement of the third brake light is intended to prevent rear impact crashes by enabling a following vehicle to react more quickly to the front vehicle's braking. Such an indicator does not communicate the use of a vehicle's accelerator. Placement of an indicator solely in the front windshield of a vehicle would not be effective when a moving vehicle is observed from the side.

U.S. Pat. No. 5,594,415, issued to Ishikawa on Jan. 14, 1997, discloses a sensor and external indicator showing the degree of the operation of a vehicle's accelerator. An indicator showing the degree of the use of the brake pedal is also disclosed. Such indicators are shown both inside and outside of the vehicle. This patent also discloses the use of a blue lens over a rear facing light indicator, but does not claim such a blue or green lens in conjunction with the other features of the invention.

U.S. Pat. No. 5,379,198, issued to Zhang on Jan. 3, 1995, discloses a forward facing “courtesy lamp system” mounted above the dashboard of a vehicle which is installed into a housing located in the back surface of the rearview mirror, and which includes red and green lights. The red lights are coupled to the brake light system of the vehicle and are illuminated when the vehicle's brake pedal is depressed. The green lights are controlled by a manual switch, and are used by the driver to flash signals to pedestrians or other drivers. However, there is no disclosure of connecting these green lights to the accelerator of the vehicle.

U.S. Pat. No. 5,373,426, issued to O'Sullivan on Dec. 13, 1994, discloses a front-mounted vehicle brake light signal assembly which is electrically coupled to both the brake lights of the vehicle and a variable rate flasher. Upon depression of the brake pedal, the signal assembly illuminates or flashes to indicate the vehicle's deceleration. An accelerator indicator is not disclosed.

U.S. Pat. No. 5,255,165, issued to Cail on Oct. 19, 1993, discloses an after-market brake light assembly adapted for mounting on the inside surface of a vehicle's front windshield. The brake lights are configured as a series of lights in a column which is electrically coupled with a vehicle's conventional brake light system. An accelerator indicator is not disclosed.

U.S. Pat. No. 5,025,245, issued to Barke on Jun. 18, 1991, discloses a pedestrian signal system for automobiles which incorporates an alternating flasher into a main signal system of the vehicle via a relay. The flasher allows the driver to communicate to a pedestrian thus potentially reducing the number of vehicle-pedestrian collisions. Such auxiliary system is operated by a momentary pressure on a push button and by the application of pressure to the vehicle brake pedal. The system automatically shuts off after a predetermined time upon a release of the brake pedal.

Likewise, U.S. Pat. No. 4,940,962, issued to Sarokin on Jul. 10, 1990, discloses an auxiliary light system for automobiles where the lights are responsive to depression of a vehicle's brake pedal and the vehicle's speed. Although the lights are mounted on the front of a vehicle, the lights are located at the bottom of the front bumper rather than being “high mounted” and do not communicate the state of the accelerator pedal.

U.S. Pat. No. 4,837,554, issued to Gianforcaro Jun. 6, 1989, discloses a vehicle signaling system comprising differently colored lights indicating the character of the motion of a vehicle. When a vehicle brake pedal is depressed and the car is in motion, red lights are flashed, whereas when the brake is depressed and the car is stopped green lights are flashed.

U.S. Pat. No. 4,682,146, issued to Friedman on Jul. 21, 1987, discloses a rearward facing indicator light system employing a single horizontal indicator which provides braking, parking, emergency flasher, and turn indications. The indicator is operated at partial intensity for a parking function and full intensity for a braking function.

U.S. Pat. No. 4,149,141, issued to Tanimura on Apr. 10, 1979, discloses a vehicle light assembly for indicating operating conditions of the vehicle to drivers of trailing vehicles. The invention comprises a rotatable lamp housing having green and amber lamps on one side thereof and a red lamp on another side. A position switch is associated with the accelerator pedal of the vehicle to light the green lamps when the accelerator pedal is depressed. A pressure switch provides a means for extinguishing the green lamps and lighting the amber lamps upon a decrease of the intake pressure of the engine below a predetermined level. A switch extinguishes the green and amber lamps, lights the red lamp, and energizes a rotating mechanism when braking the vehicle. This patent also discloses the use of a blue lamp in place of a green or amber one. However, there is no teaching of a forwardly visible or topward facing indicator.

U.S. Pat. No. 3,665,392 issued to Annas on May 23, 1972, discloses a driver communication signal light mounted on the front windshield connected to the vehicle brakes for indicating to pedestrians and other drivers when the driver has applied his brake.

U.S. Pat. No. 3,634,792, issued to Blomenkamp on Jan. 11, 1972, discloses an apparatus for determining the acceleration and deceleration of a vehicle in which an electromechanical sensing device generates an output signal in response to the rotation of a shaft turning at a fixed ratio to the vehicle drive shaft. Electronic circuitry processes the signal of the sensing device for continuous monitoring of acceleration and deceleration on a meter, and for operating rear facing light signals indicating levels of acceleration and deceleration in a system that is integrated with conventional brake and reverse light systems.

U.S. Pat. No. 3,364,384 issued to Dankert on Jan. 16, 1968, discloses a signaling system for indicating a vehicle driver's actions. The system consists of a specially designed light mounted on the front of the vehicle and connected to sensors within. The light provides different colored visual signals depending upon whether the vehicle is at constant speed, accelerating, or decelerating.

U.S. Pat. No. 2,740,105 issued to Dorfman et al. on Mar. 27, 1956, discloses a red, amber and green light indicator system similar to that used as a street semaphore. The indicator system is designed to hang in the rear window of a car. The green light is lit when the accelerator is being used, the amber light is lit when the vehicle is coasting or slowing down, and the red light is lit when the brakes are being applied. There is no teaching to mount such a device in a forward facing position.

U.S. Pat. No. 2,190,123, issued to Page on Feb. 13, 1940, discloses a manually-activated indicator lamp box intended to be mounted in a vehicle, in the area of the rearview mirror, which indicates to pedestrians that the driver is yielding the right of way to pedestrians.

U.S. Pat. No. 1,553,959 issued to Pirkey on Sep. 15, 1925, discloses a manually-operated, switch-controlled turn and brake signal lamps for the front and rear of a vehicle.

Published U.S. Patent Application 2002/0105423 submitted by Rast on Aug. 8, 2002 entitled “Reaction Advantage Anti-collision Systems and Methods” discloses a vehicle anti-collision system and method which provides drivers with additional time in which to react to significant roadway events. One implementation of Rast's system employs a brake pedal mounted sensor for determining how hard a driver is braking. Hard braking information is relayed to approaching drivers by means of the reverse lights of the vehicle. Other embodiments include the use of white or blue LED's. The disclosed system is only for rearward facing indicators.

U.S. Pat. No. 3,192,438 issued to Deputy on Jun. 29, 1965, discloses a fog penetrating light and a light for signaling between two users. A flashing light provides increased visibility through fog-like conditions as compared to lights which are constantly on.

U.S. Pat. No. 6,456,206 issued to Rocca et al. on Sep. 24, 2002, discloses strobing headlights and fog lights for severe weather conditions. Such strobing lights warn other vehicle drivers to the presence of the vehicle. The invention controls any number of lights, not just the taillights or headlights. The invention does not use a sensor to just detect foggy or rainy conditions (reduced visibility) but also uses a moisture sensor. The invention also provides for an increase in voltage to existing, conventional lights for increased light intensity under adverse driving conditions.

U.S. Pat. No. 5,798,691, issued to Kao on Aug. 25, 1998, discloses an accessory brake light system for the front of an automobile consisting of a plurality of LEDs mounted in an elongated housing. By flashing in different sequences, the LEDs can provide various warning signals to indicate braking conditions of the automobile, such as whether the vehicle is fully stopped, slowing down, or accelerating. Such a system is not visible from the rear of a vehicle.

Despite these prior art references which disclose various brake and accelerator indicators and hazardous weather light systems, there remains a need in the transportation industry for an inexpensive light system which provides improved visibility to vehicles and which provides improved information to observers and other vehicle operators.

Further, despite these and other prior patents and patent applications disclosing various brake light or acceleration/deceleration indicators, there remains a need in the transportation industry for an inexpensive detection system which provides brake and accelerator indicators which communicate more accurately and effectively to a trailing vehicle. A need exists for such indicators which are visible from the front, top, side and rear of a vehicle. More specifically, there is a need for easily viewable and distinguishable indicators, including flashing and/or non-flashing visual cues and/or audio cues that indicate the use of an automobile's turn signal, accelerator and brakes and can communicate whether the vehicle is turning, coasting, accelerating, or braking in clear weather and adverse driving conditions. The need becomes more pronounced as driving conditions change. A further need exists for an aesthetically pleasing combination of color indicators which may be universally implemented in existing and manufactured vehicles.

Changing driving conditions are not limited to changes in weather. For example, a changing driving condition can occur when two vehicles are traveling in the same direction in the same lane of traffic. Travel in such configuration is typical with the lead vehicle, traveling at a first speed, and a trailing or following vehicle, traveling at a second speed behind the lead vehicle. So long as the first speed is equal to or greater than the second speed, travel in such configuration is safe. However, there are instances where the lead vehicle must rapidly reduce its speed. If the operator of the trailing vehicle fails to concomitantly reduce its speed a collision can occur between the trailing vehicle and the leading vehicle. There are several scenarios that can lead to such a collision. If the operator of the trailing vehicle is distracted by, for example, adjusting the radio or dialing on a cell phone, the trailing vehicle may not concomitantly reduce its speed, resulting in a collision event with the lead vehicle.

Changing driving conditions can also occur in when a vehicle enters an area having pedestrian traffic. As discussed above, it is desirable to convey braking and acceleration information to pedestrians from nearby vehicles to increase the safety of pedestrians. Consequently, a need exists for a safety signaling system that changes in response to changing driving conditions that can occur in clear weather. Moreover, visibility can be reduced as vehicles travel into an area of heavy rain, snow or fog. Consequently, a need exists for a safety signaling system that changes in driving conditions that can occur due changes in weather. In summary, a need exists for detecting a potential collision event that can occur as a result of changing driving conditions, including changing conditions that can be triggered by inclement weather, that can be triggered by sudden changes in vehicle velocity, or that can be triggered at certain vehicle velocities so that damage from the potential collision event can be mitigated or avoided.

### SUMMARY OF THE INVENTION

The present invention provides a method for changing the safety signaling system to conform with changing driving conditions.

In one aspect, the present invention provides a method for detecting a potential collision event based upon a velocity differential between a leading and a trailing vehicle. The instant invention can be utilized by either a leading car or a trailing car. A distance sensor or proximity detector can be used to can be used to calculate a velocity differential. The velocity differential is used to calculate a collision time. If the calculated collision time becomes less than or equal to a pre-determined threshold, a signal is triggered. The signal can be used to warn the operator of the leading car that a collision may be imminent and can be used to warn the operator of a trailing car that measures can be taken to avoid a collision or minimize damage from a collision. In one embodiment, the signal can be adjusted by an operator. For example, the volume of an audio signal can be adjusted manually.

In one aspect, the present invention relates to an improved method of increasing the visibility of a vehicle that is in fog or other diminished visibility situation such as a fog, rain, dust storm. In one embodiment, the basic element of the invention is flashing the vehicle's lights. In one embodiment, the flashing indicator is placed adjacent a non-flashing indicator. In an alternative embodiment, the flashing indicator is placed in a location that is non-adjacent the non-flashing indicator. In one embodiment, the flashing is performed with a particular color or set of colors.

In one aspect, improved indicators for the use of brakes and accelerator as well as turn signals for vehicles are disclosed. Visual indicators of braking, coasting, turning, and acceleration can be visible from the front, top, sides and rear of a vehicle. An accelerator, brake, coasting, or turn indicator for a vehicle can be externally visible, but may not be visible to an operator, and does not interfere with vehicle operation at night or under low visibility conditions. One or more indicator colors can be chosen so as to be aesthetically pleasing or to communicate a certain vehicle condition. Indicator design and placement are also chosen so as to be aesthetically pleasing. Improved indicators are suitable for installation into any type or style of vehicle. Such improved indicators may be installed at manufacture time. Indicators may be positioned upon a vehicle in conventional locations.

Improved indicators may be retrofitted into an existing light system of an existing vehicle. In one embodiment, a first color indicates a brake and a second color indicates acceleration and a turn or coasting signal can be indicated by the first or second color. In one three-color embodiment, a first color indicates a brake, a second color indicates acceleration and a third color indicates a turn or coasting signal. In one four-color embodiment, a first color indicates a brake, a second color indicates acceleration, a third color indicates a turn and a fourth color indicates a coasting signal. In one embodiment, improved accelerator, coasting, brake, and turn indicators comprise a housing including a reflective shell and one or more transparent or translucent lenses forming a sealed enclosure, a socket, at least one light producing element, a means to electrically connect a socket to the vehicle's electrical system, and a means to electrically connect a socket to a logic device and sensor which are attached to the vehicle's accelerator system, brake system, and/or turn signal system. The means to electrically connect a socket to the accelerator system, brake system, and turn signal system of the vehicle allows an accelerator light, brake light, and turn light to be illuminated or flashed when the respective systems are used. Similarly, the means to electrical connect a socket to the electrical system allows a coasting light to illuminate when neither the vehicle accelerator nor the vehicle brakes are used. The sockets and reflective shell are disposed in the housing. The sockets each have at least one light producing element or light bulb inserted therein.

One object of the present invention is to automatically provide a warning system to drivers during adverse driving conditions including poor weather and hard braking.

Another object of the present invention permits an operator to utilize a clear weather signaling system and an adverse signaling system simultaneously.

One object of the present invention is to automatically provide a warning system to drivers that indicates hard braking or rapid deceleration of a vehicle.

One object of the present invention is to allow for the flashing of the brake lights to increase visibility.

Another object of the present invention relates to increasing a vehicle's visibility by flashing lights other than the brake lights.

Another object of the present invention relates to alerting an operator of a vehicle to a potential collision event.

Another object of the present invention relates to triggering an appropriate signaling system (e.g. visual cues in flashing or non-flashing states on vehicle exterior or interior such as the dashboard and internal or external audio cues) that communicates a safety zone violation to one or both vehicle operators wherein the signaling system selected is based on the relative speed of the vehicles and the distance between the vehicles.

Another object of the present invention is to increase or decrease the rate of flashing based on the speed of the vehicle.

Another object of the present invention is to increase or decrease the rate of flashing based on a distance between a first vehicle and a second vehicle.

Another object of the present invention is to increase or decrease the rate of flashing based on a collision time between a first vehicle and a second vehicle.

Another object of the present invention is to increase or decrease the intensity of flashing based on the speed of the vehicle.

Another object of the present invention is to increase visibility of the vehicle in response to the weather and visibility conditions.

Another object of the present invention is to increase or decrease the intensity of flashing based on a distance or collision time between a first vehicle and a second vehicle.

Another object of the invention is to flash lights in a sequence to indicate a vehicle's actions, for example to turn left or right during braking, acceleration, or coasting.

Another object of the invention is to trigger the rate, intensity, pattern, color scheme, or sequencing of flashing lights and/or bulb lights based on various sensors on the vehicle, including a visibility detector, a distance sensor, a humidity sensor, a hygrometer, a sensitometer (photometer), thermometer, a manual switch, a transmission sensor, a gear sensor, a brake sensor, accelerator sensor, turn signal sensor, and/or a speedometer sensor.

Another object of the present invention relates to the use of audio cues including the vehicle's horn and/or sound system to supplement the use of flashing lights to increase a second vehicle's awareness of the first vehicle.

Another object of the present invention is to provide an indicator to the vehicle's driver showing the status of the various lights and sensors.

The invention accordingly comprises the advantages and features described more fully below, and the scope of the invention will be indicated in the claims. The objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a rear view of a motor vehicle showing conventional brake, running and reverse indicator lights according to the prior art;

FIG. 2 is an oblique perspective view of a motor vehicle showing typical headlights, fog lights, and turn signal lights according to the prior art;

FIGS. 3A-C are front oblique perspective views showing various embodiments of the present invention;

FIGS. 4A-D are rear views of a vehicle showing various embodiments of the present invention;

FIG. 5A-B are top views of a vehicle depicting top facing lights in accordance with one embodiment of the present invention;

FIG. 5C depicts a fixed-mounted and retractable indicator antenna in both the retracted and protruding state in accordance with one embodiment of the present invention;

FIG. 6 is a side view of a vehicle showing side mounted brake, accelerator, coasting, and turn indicators attached to the front and rear regions of the vehicle, and a side mounted rearview mirror having attached brake, accelerator, coasting, and turn indicators, according to one embodiment of the present invention;

FIG. 6A is a close up view of side mounted indicators on the front region of a vehicle as shown in FIG. 6;

FIG. 6B is a close up view of side mounted indicators attached to, and forming part of, a side mounted rearview mirror as shown in FIG. 6;

FIG. 6C is a close up view of side mounted indicators forming part of a vehicle's door handle as shown in FIG. 6;

FIG. 6d depicts an alternative indicator light embodiment having a three color unit with no lens cover;

FIG. 6e depicts an alternative embodiment wherein the colors are provided to the various indicator lights with a lens;

FIG. 7A is an overhead view of a two-stop, four-way intersection in a clear weather condition in accordance with one embodiment of the present invention;

FIG. 7B is a top view showing a group of vehicles located at an intersection where the visibility at the intersection is reduced due to adverse weather in accordance with one embodiment of the present invention;

FIG. 8A is an overhead view of a two lane road showing advantages of an improved accelerator, coasting, and braking indicators according to the present invention;

FIG. 8B is a rear perspective view of a two lane road of FIG. 8A showing advantages of an improved accelerator, coasting, and braking indicators according to the present invention;

FIG. 8C is an overhead view of a two lane road showing advantages of an improved flashing light indicator in accordance with one embodiment of the present invention;

FIG. 8D is an overhead view of a two lane road showing advantages of an improved flashing light indicator in accordance with one embodiment of the present invention;

FIG. 9 is a side view of cars in states of varying driving conditions.

FIG. 10 is a graphical representation of a safe range based upon a vehicle velocity and weather condition.

### REFERENCE NUMERALS

102 yellow, orange or amber for turning or running light
104 forward facing headlights
106 running light or fog light
201 yellow, orange or amber for turning or running light
205 brake light
206 centrally located brake indicator light
208 reverse drive indicator light
302 forward facing coasting or turning indicator
305 forward facing accelerator indicator
308 forward facing brake indicator
310 side mounted rearview mirror coasting or turning indicator
313 side mounted rearview mirror accelerator indicator
315 side mounted rearview mirror brake indicator
316 lower forward facing coasting or turning indicators
317 lower forward facing accelerator indicator
318 lower forward facing brake indicator
321 windshield mounted accelerator indicator
324 windshield mounted brake indicator
330 door mounted coasting or turning indicator
331 door mounted accelerator indicator
333 door mounted brake indicator
351 rearward facing coasting or turning indicator
354 rearward facing accelerator indicator
357 rearward facing brake indicator
362 rear window accelerator indicator
363 rear window coasting indicator
364 rear window mounted brake indicator
371 top facing turn or coast indicator
372 top facing accelerator indicator
374 top facing brake indicator
402 forward facing flashing coasting or turning indicator
405 front facing flashing accelerator indicator
408 forward facing flashing brake indicator
410 side mounted rearview mirror flashing coasting or turning indicator
413 side mounted rearview mirror accelerator flashing indicator
415 side mounted rearview mirror flashing brake indicator
416 lower front facing flashing coasting indicator
417 lower front facing accelerator flashing indicator
418 lower front facing flashing brake indicator
421 windshield mounted flashing accelerator indicator
424 windshield mounted flashing brake indicator
430 door mounted flashing coasting or turning indicator
431 door mounted flashing accelerator indicator
433 door mounted flashing brake indicator
454 rearward facing accelerator flashing indicator
455 rearward facing flashing coasting or turning indicator
457 rearward facing flashing brake indicator
462 rear window accelerator flashing indicator
463 rear window flashing coasting or turning indicator
464 rear window flashing brake indicator
471 top facing flashing coasting or turning indicator
472 top facing flashing accelerator indicator
474 top facing flashing brake indicator
491 color indicator light
492 color indicator light
493 color indicator light
494 color indicator light
495 color indicator light
496 color indicator light
497 color indicator light
498 vehicle surface
499 telescoped position
701 side mounted indicator unit near front of vehicle
703 turn or coasting indicator
705 accelerator indicator section of side mounted indicator unit
707 accelerator light element of accelerator indicator
708 brake indicator section of side mounted indicator unit
709 brake light element of brake indicator
710 side mounted indicator unit as part of door handle apparatus
711 vehicle door handle
712 vehicle door key lock
715 accelerator indicator
718 brake indicator
720 side mounted indicator unit attached to side mounted rearview mirror
725 brake indicator attached to side mounted rearview mirror
731 accelerator light colored lens
733 brake light colored lens
735 turn light colored lens
750 side mounted indicator unit near rear of vehicle
760 side mounted indicator unit near wheel well
800 obstacle
812 stopped car near crosswalk
814 moving car
816 pedestrian
818 crosswalk
820 stopped car opposite crosswalk
830 fog
832 lead car in left lane
834 lead car in right lane
836 first following car in left lane
837 first following car in right lane
838 second following car in the left lane
839 second following car in right lane
840 right lane
850 left lane
860 braking cars
862 coasting cars
864 accelerating cars
952 car
954 car
956 car
958 car
960 car

### DETAILED DESCRIPTION

While the invention is described below with respect to one or more preferred embodiments, other embodiments are possible. The concepts disclosed herein apply equally to other systems for externally indicating acceleration, deceleration and braking of an automobile or other vehicle through detecting the use of a vehicle's brakes and accelerator. Further, in one aspect, the invention is directed towards improved turn indicators. The instant invention can be used with any vehicle that can use a signaling system including, but not limited to any motor vehicle, automobile, mass transportation vehicle, truck, tractor trailer, bus, school bus, commercial vehicle, commercial equipment, industrial equipment, military vehicle, snowmobile, watercraft including jet skis and boats, submarines, and ships, scooter, motorcycle, minibike, bicycle, go-cart, moped, unmanned vehicle, toy car, toy ship, or toy aircraft and aircraft. The instant invention can be used with any vehicle that can use an indicator for signaling. It will be readily apparent to those skilled in the art that various modifications, rearrangements, and substitutions can be made without departing from the spirit of the invention. The scope of the invention is defined by the claims appended hereto.

The present invention is directed towards providing an improved signaling system for motor vehicles. As used herein, a signaling system refers to a combination of audio and/or visual cues in a certain configuration. The signaling system of the present invention, in one aspect, provides motor vehicle operators and motor vehicle observers more information about the state of operation of a motor vehicle (whether a vehicle is accelerating, braking, rapidly braking, turning, or coasting.) Communication indicators that can be placed both externally and internally, and can transmit both through audio and visual cues about the state of operation of a motor vehicle results in greater safety because it permits vehicle observers, which can be pedestrians or vehicle operators, more time to respond to changing driving conditions.

In one aspect, the present invention relates to a novel system for improving the visibility of a vehicle in reduced visibility conditions. A first vehicle is equipped with the means for flashing its lights based on an automatic or driver's manual input or any number of sensors that will be discussed below. The flashing can be made more effective by altering its rate or its intensity or by flashing the lights in a particular sequence. The driver can also be kept informed with a monitor that shows the status of the flashing. Various sensors can be used to trigger the flashing. The flashing makes the first vehicle more conspicuous to a second vehicle. A flashing light embodiment is not limited to use in reduced visibility conditions, however, as such system can also be useful to alert vehicle operators of a rapid deceleration of a vehicle that, in one embodiment, is the result of hard braking. Hard braking may be defined as a deceleration of the vehicle meeting or exceeding a minimum threshold deceleration. It should be noted that anytime the invention discusses use of an illuminated light, it should be construed to include a flashing embodiment.

In one aspect, an externally visible accelerator indicator installed in a vehicle provides beneficial information to observers. One or more lights indicate whether an operator is using a vehicle's accelerator. In one embodiment, an indicator is off when the accelerator is in use, and lit when the accelerator is not in use. In another embodiment, an accelerator indicator is on or lit when the accelerator is in use, and off when the accelerator is not in use. In another embodiment, an accelerator indicator is dimly lit when the accelerator is in use, and brightly lit when the accelerator is not in use. In another embodiment, an accelerator indicator is brightly lit when the accelerator is in use, and dimly lit when the accelerator is not in use. In yet another embodiment, an indicator is illuminated for a fixed amount of time beginning from the point when a vehicle's accelerator is disengaged from use. The accelerator indicator can be off and can have two or more intensities and can flash or be steady. It can be dimly lit or brightly lit.

The invention will next be discussed by first giving examples of lights and locations of the various signaling indicators. Next, a discussion describing the various indicators that can be used in various clear driving weather condition scenarios in accordance with several embodiments of the present invention will be provided. The discussion that follows is directed towards various embodiments of the present invention that can be used in adverse weather conditions.

Signaling Indicator Lights and Locations

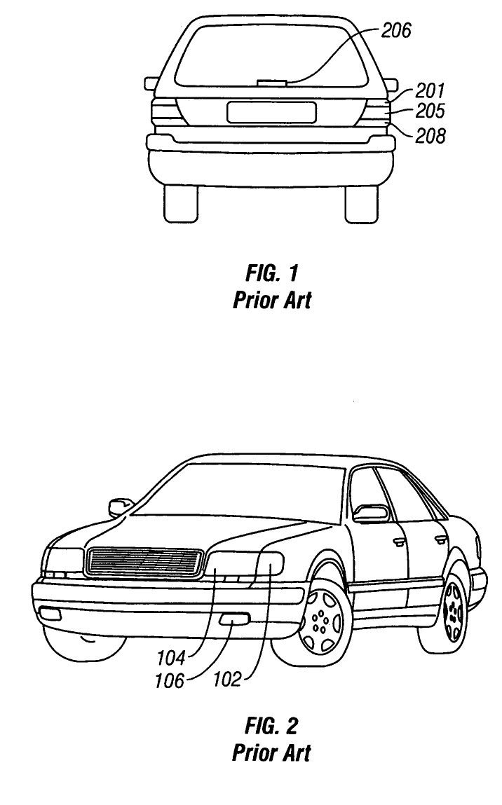

As shown in FIGS. 1 and 2, a car is already equipped with a variety of lights: headlights, brake lights, turn indicator lights, reverse indicator lights, and so forth. These can be located in a variety of locations on the vehicle, including the front, rear and sides. Such accelerator and brake indicators may be illuminated in a variety of intensities including, but not limited to, low, medium and high intensity states, or lower, equal and higher states relative to coasting lights, emergency lights, conventional brake lights, or headlights. The states of such indicators may be of any intensity, duration, or pattern. One state of a brake indicator is of a constant intensity for a predetermined amount of time as either the brake or accelerator is engaged. Likewise, one state of an accelerator indicator is of a constant intensity for a predetermined amount of time as either the brake or accelerator is engaged.

In one, two-color indicator embodiment of the present invention, and with reference to FIG. 1, existing rear amber turn signals or running lights 201 comprise and are used as rearward facing accelerator indicators. Such amber lights 201, functioning as accelerator indicators and turn indicators, may be replaced by indicators of any color such as, but not limited to, blue or green indicators. Similarly, and with reference to FIG. 2, existing forward amber turn signals or coasting lights 102 comprise and are used as forward facing accelerator indicators and turn indicators. Similarly, such forwardly mounted amber lights 102, functioning as accelerator indicators, may be replaced by indicators of any color. Internally, such accelerator indicators, both forward or rearward, also contain an appropriate logic device (not shown) and sensor device (not shown) which allows such indicators to function when an accelerator is engaged or disengaged.

In another embodiment, an additional indicator functioning as an accelerator indicator is mounted in a rearward facing direction. Such a rearward facing accelerator indicator can be, but is not limited to being mounted as part of or near a vehicle's taillights. In another embodiment, an accelerator indicator is mounted in any location in the rear region of a vehicle. In another embodiment, an accelerator indicator is mounted solely in a forward facing direction on the front region of a vehicle. In yet another embodiment, an accelerator indicator is mounted in a rearward facing direction on the rear region of a vehicle, and is separately mounted in forward facing direction on the front region of a vehicle.

In another embodiment, an accelerator indicator is solely mounted on the side of a vehicle. Such a side mounted accelerator indicator is visible from a side, generally forward and generally rearward directions relative to the vehicle. In another embodiment, one or more accelerator indicators are mounted on the side, top-facing, forward and rearward regions of a vehicle. In such embodiments, an accelerator indicator may form part of a turn indicator or indicator system.

In another embodiment, a brake indicator is mounted in a rearward facing direction on the rear region of a vehicle, and a brake indicator is separately installed in a forward facing direction on the front region of a vehicle. In another embodiment, a brake indicator is mounted on the side region of a vehicle. Such a side mounted brake indicator is visible from a side, generally forward and generally rearward directions relative to the vehicle. In one embodiment, one or more brake indicators are mounted on the side, top facing, forward, and rearward portions of the vehicle. A brake indicator may be mounted in the same or adjacent housing as the accelerator indicator. A brake indicator may be combined with an accelerator indicator to signal that a driver is applying a vehicle's brakes. Such use of a colored or colorless indicator makes it easier for observers to notice that a vehicle is stopping.

An indicator may be illuminated for any length of time and may be extinguished upon the occurrence of another event. A pattern may be of any repeated or predictable sequence of short or long illuminations of the indicators. A pattern also may be any combination of the use of one or more of such indicators illuminated in a repeatable sequence. A pattern may be an illumination, blinking or flashing sequence. In one embodiment, a brake indicator flashes indicating the engagement or disengagement of an accelerator.

Light for an accelerator, brake, turn, or coasting indicator may be generated by any means. Light may be generated directly, e.g. from a light emitting bulb, or it may be generated by a filter or colored translucent lens mounted over a device emitting light at one or more other frequencies. In one embodiment, an indicator comprises an LED, LCD, or other light emitting device instead of a conventional or halogen light bulb. Thus, the indicator can comprise a light source wherein the light source emanates from a bulb, a strobe light, an LED, an LCD, a halogen, or any other light source. In one embodiment, the indicator comprises a housing, a reflective shell, a socket, and a light emitting component such as, but not limited to, a light bulb. Such indicator can be covered by its own separate lens covering the lens covering can be clear, translucent, or colored. In one embodiment, an indicator comprises a housing, a reflective shell which is attached to a translucent lens and which forms a sealed enclosure, and a light bulb removably inserted into an electrical socket. The socket is coupled to a logic device and a vehicle's electrical system by wires such that an attached indicator emits light when energized. For example, a socket and light bulb for an accelerator, brake, turn, and coasting indicator would be as inexpensive and as easy to manufacture and install as conventional taillights, coasting lights, fog lights and headlights. In one embodiment, a conventional turn light indicator can be used as a coasting light, reducing the need of having an additional light.

Further, in each embodiment, it is implicit that there is a sensing device, operating software program, and logic device associated with each external or internal accelerator, coasting, turn and brake indicator. It will be obvious to those in the art that an improved accelerator indicator, turn indicator, coasting indicator, or brake indicator as described herein would not function without such components. Such sensing and logic devices are hereby implicitly incorporated.

In one embodiment, accelerator, coasting, turn, and/or brake indicators comprise an existing housing and existing reflective shell combined with an existing translucent lens and a new electrical socket attached to the existing housing. Accelerator, coasting, and/or brake indicators may thus be retrofitted into an existing vehicle with the addition of a new electrical socket and an additional sensing and logic device attached to a vehicle's accelerator system.

In another alternative, an accelerator or brake indicator may use existing turn signal indicators and coasting lights with the addition of an additional sensing device and logic device attached to a vehicle's accelerator system.

Those skilled in the art will recognize the various ways that can convey the information that an accelerator indicator light(s) is on when the accelerator is engaged, the brake light indicator(s) is on when the brake is engaged, and that coasting light(s) are on when the neither the accelerator nor the brake is engaged. There are innumerable foreseeable embodiments of accelerator, coasting and brake indicators. Several physical embodiments are presented here. The below will explain several two-color and three-color embodiments, however, it should be pointed out that such examples are for purposes of illustration and not limitation.

Two Color Embodiment

In clear weather driving conditions, a two color signal indicator wherein a first color indicates a brake and a second color indicates acceleration can be used in accordance with one embodiment of the present invention. The brake indicator can be red or some other color and the accelerator indicator can be green or blue or any other color except it cannot be the same color as the brake indicator. In such an embodiment, either the accelerator or brake indicator can also be used for a turn indicator. Each indicator can also be configured to have a first intensity (level 1) and a second intensity (level 2) wherein the first intensity is different (either greater than or less than) from the second intensity.

An accelerator indicator can be dimly lit or dimly glows when the accelerator is engaged. When the accelerator indicator is disengaged, the accelerator indicator can be continuously and brightly lit until such time as the occurrence of a measurable event. Such event includes, but is not limited to, when the accelerator is re-engaged, the brakes are engaged, a timer expires, the electrical system of the vehicle is turned off, the light system of the vehicle is turned off, and the steering wheel is turned a predetermined amount. In an alternative embodiment, an accelerator indicator is off when the accelerator is engaged, and the indicator is on, lit or glows when the accelerator is disengaged. In a further alternative embodiment, an accelerator indicator is on, lit or glows when the accelerator is engaged, and the indicator is off when the accelerator is disengaged.

Three Color Embodiment

In accordance with one embodiment of the present invention a three color signaling system can be used wherein a first color indicates a brake and a second color indicates acceleration and a third color indicates a turn and/or coasting signal. In one aspect of this embodiment, the turn indicator can be used to indicate a turn and the brake or accelerator indicator can be used to indicate coasting. In one embodiment, the turn signal indicators are also used as coasting indicators. The brake indicator can be red or some other indicator and the accelerator and turn/coasting color can be green or blue or any other color except it cannot be the same color as the brake indicator. The accelerator indicator could be green, while the brake indicator could be red, and the coasting or turn indicator could be amber. Such colored indicators provide improved safety or warning lights in clear weather or in hazardous or inclement weather as following vehicles can better ascertain whether a lead vehicle is braking, accelerating, turning or coasting if such functions are tied to color.

In this invention, an accelerator indicator may be of any visible color. In one embodiment, a light bulb emits blue light which is defined as electromagnetic radiation in the visible spectrum having a wavelength of approximately 470 nm. Similarly, a light bulb emits green light at approximately 550 nm. However, in other embodiments, light is emitted at other frequencies which either combine to form blue or green light, respectively, or emanate through a colored lens thereby presenting a blue or green color, respectively. Blue or green light as used in this invention is not merely that color as strictly and conventionally used but encompasses other shades or variations at or near blue or green on an artist's color wheel, respectively.

Blue, as used for an accelerator indicator, is aesthetically pleasing and is nearly opposite to the red as used in conventional brake lights on an artist's color wheel. Blue light is one of the three primary additive colors along with red and green. Alternatively, an accelerator indicator may use a green hue. Blue is also chosen to complement traditional red and amber vehicle indicator lights. The perception of color is a biological phenomenon and is influenced by short-term effects such as the presence of nearby colors.

Each indicator can also be configured to have a first intensity (level 1) and a second intensity (level 2) wherein the first intensity is different (either greater than or less than) from the second intensity.

In one embodiment, an indicator such as a brake or acceleration indicator can be mounted on one or more antennas attached to the vehicle. The use of accelerator and brake indicators together may indicate the coasting of or turn of a vehicle. Further, improved accelerator, coasting, turn, and brake lights may be programmed, or contain a pre-programmed logic component, to provide more meaningful communication in emergency situations. For example, police already use emergency lights which illuminate or flash red and blue in an alternating pattern. It would be beneficial for any stopped or operating vehicle to have an indicator system which would provide more meaningful, brighter or increased number of indicator lights. In such an embodiments, all indicators (brake, acceleration, turn, and coasting; side-mirror mounted, door mounted, front facing, rear facing, side mounted rearview mirror, top facing, front window mounted, etc.) can be used as emergency indicators, as a guide light to permit a following car to easily track and see the lead car in heavy traffic, and/or to communicate the location of a parked vehicle in a crowded parking lot.

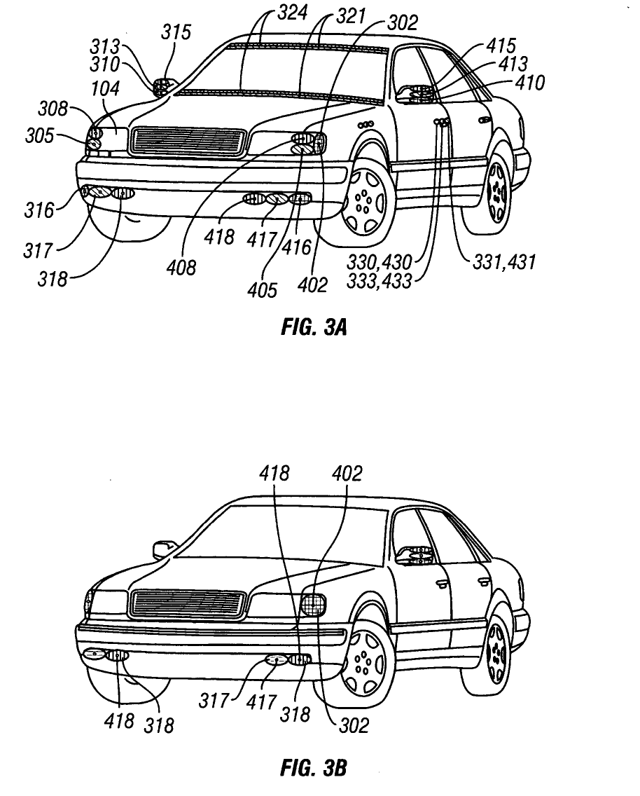

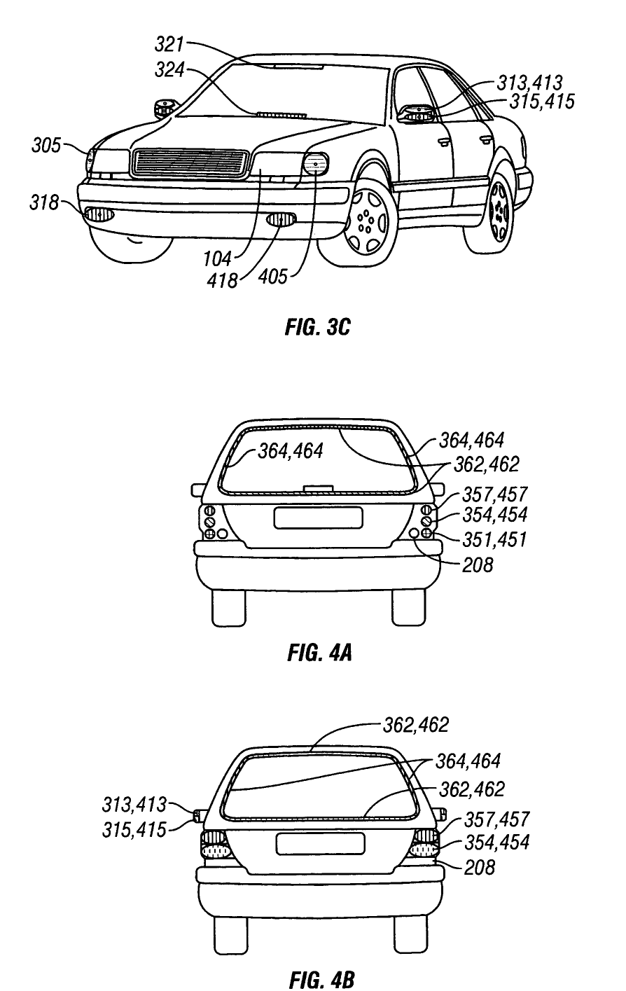

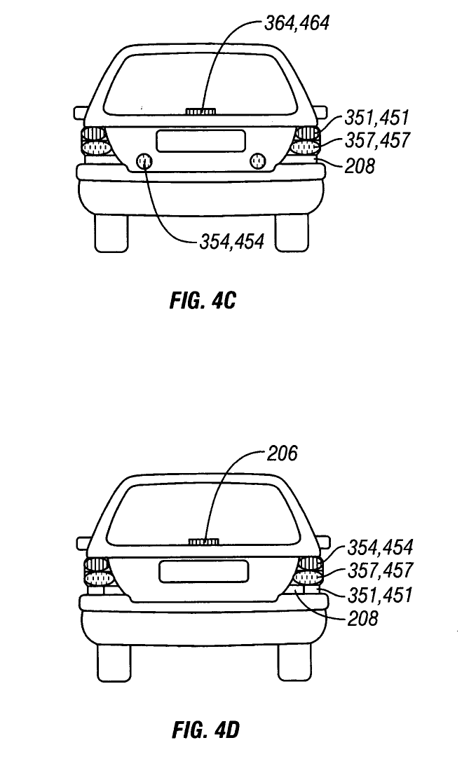

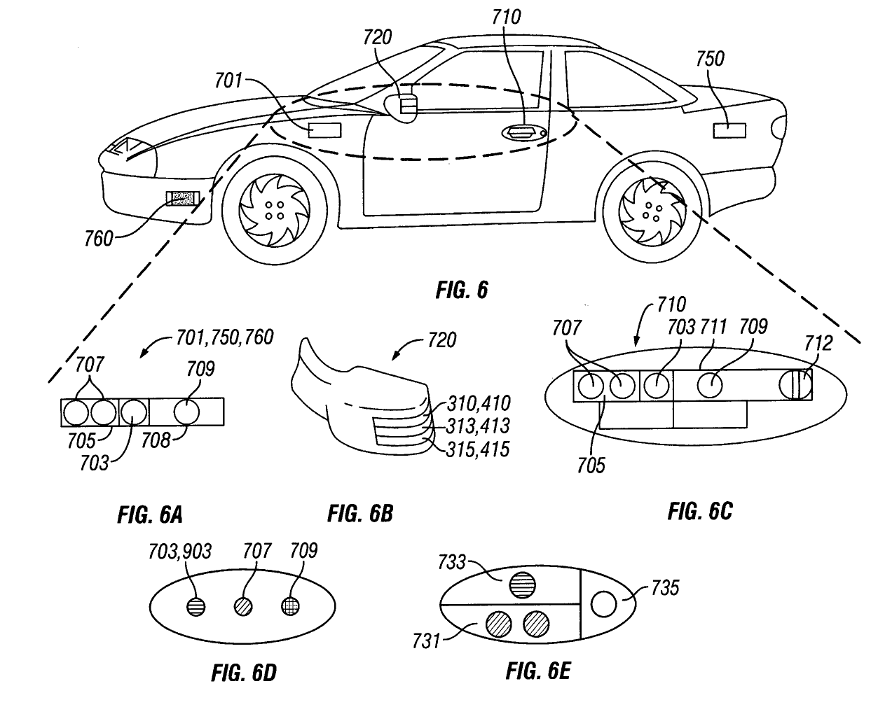

Improved accelerator, coasting, turn, and brake indicators according to the present invention, being mounted on the front, sides, top, or rear of a vehicle, would provide such ability and benefits. Accordingly, the following Figures are offered to describe various embodiments of the present invention. FIGS. 3A-C are front oblique perspective views depicting the various potential locations of indicator lights on the front and sides of the vehicle. FIGS. 4A-D depict the various potential locations of indicator lights on the rear of the vehicle. FIG. 6 and its associated figures depict the various potential locations of indicator lights on the side of a vehicle. Each of these Figures are discussed in more detail below.

With reference to FIG. 3A, in one three-color embodiment, a forward mounted accelerator indicator 305 is an additional light which is added to a conventional headlamp or headlamp enclosure or is comprised of a separate housing, reflective shell, translucent lens, and a light bulb or other light element inserted into an electrical socket. Such separate unit can be mounted near or next to an existing headlamp 104, and/or next to an existing side mounted amber coasting or turn signal indicator 316. Such additional indicator 305 can be a light which is similar in size, shape and intensity as a conventional amber coasting light 316. Alternatively, an accelerator indicator light apparatus may be mounted near a headlamp enclosure and a separate accelerator indicator light apparatus may be mounted on the side of the forward region of a vehicle.

In an alternative three color embodiment, and with reference to FIG. 3A, the lower forward facing accelerator light 317 can be placed adjacent to a lower forward facing brake light 318 in an area below the headlight 104 in place of the amber running light 106 (as depicted in FIG. 2).

With reference to FIG. 3C, which depicts a two-color indicator embodiment, an existing amber running light (depicted as numeral 102 in FIG. 2) may be used as a forward mounted accelerator indicator 305 by attaching the running light to a new logic circuit or device (not shown), and optionally changing the color of the running light. Such accelerator indicator light 305 is preferably visible from the side and front of a vehicle. The accelerator indicator can have any suitable configuration as would be aesthetically desirable for a particular model or style of motor vehicle. For example, in the embodiment illustrated in FIG. 3C, an accelerator indicator 305 is formed so as to conform to the shape of the corner of the vehicle, or an accelerator indicator 305 is formed so as to be of arbitrary shape and mounted in an arbitrary location such as in the same location as a traditional fog light. Such accelerator indicator light 305 may be blue, aqua, green, yellow, orange, amber, magenta, cyan, silver, gold, mauve, lime, beige, or other color.

With reference to FIGS. 3A and 3C, in an alternative embodiment, a windshield mounted accelerator indicator 321 and/or a windshield mounted brake light 324 is mounted behind or near the windshield of the passenger compartment of a motor vehicle. Such indicators may be near the dashboard or near the roof of the vehicle. An accelerator indicator 321 may be mounted adjacent to a forward mounted brake indicator 324 as depicted in FIG. 3A, or in a non-adjacent location as depicted by FIG. 3C. There may be one or multiple such indicators, either grouped or dispersed, over the front of a vehicle. Such external indicator is not visible to the driver or passengers of a vehicle, but is visible to observers to the front and front oblique directions relative to a vehicle.

Accelerator indicators can also be located on the rear of a motor vehicle. In one three color embodiment, and with reference to FIG. 4A, a rearward facing accelerator indicator 354 may be located in or near a conventional taillight assembly comprised of traditional brake lights 357, amber running and turn signal lights 351, and reverse drive lights 208. In the three color embodiment, the accelerator, brake, and turn signal/coasting indicators comprise colors that are different from one another. An additional socket, bulb, and optionally an additional reflector, an accelerator sensing device (not shown), and logic device (not shown) comprise the additional elements which are needed for such an accelerator indicator 354. In many vehicles, a rear center mounted brake light is located inside the back window of the passenger compartment. In one embodiment, a rear window accelerator indicator 362 can be placed about a portion of the perimeter of the rear window and the rear window brake indicator 364 can be placed around the remaining portion of the rear window perimeter. In one variation (not shown), an accelerator indicator is located directly on one or more sides of a rear center mounted brake light. In another variation (not shown), such indicator is mounted near the roof of a vehicle. In such a variation, a vehicle's center mounted brake indicator may also be so mounted. Such location would provide improved information about the operation of a vehicle, specifically the use, or disuse, of a vehicle's accelerator. In another embodiment, one or more rearward facing accelerator indicators 362 are located near the rear center mounted brake light.

In one two-color embodiment, and referring to FIG. 4B, no additional components are needed for a rear facing accelerator indicator 354. An accelerator indicator may comprise existing running or turn signal indicators (see numeral 201 in FIG. 1) attached to a sensing device and logic device which are in turn attached to a vehicle's accelerator system. In such an embodiment, existing amber, orange or yellow running lights or turn signal indicators may be replaced by colored lights or lenses. Such an improved accelerator indicator would be one or more colors, and a brake indicator 357 would be red. In one embodiment, a rear window accelerator indicator 362 can be placed about a portion of the perimeter of the rear window and the rear window brake indicator 364 can be placed around the remaining portion of the rear window perimeter.

In another embodiment, and with reference to FIG. 4C, an accelerator indicator 354 is mounted in the trunk door of a motor vehicle. In another variation, an accelerator indicator is mounted in the bumper or bumper region of a vehicle. In one embodiment, an accelerator indicator 354 comprises a light mounted inside its own housing and is electrically connected to the electrical system of the vehicle. In this embodiment, the accelerator indicator is not adjacent to any other light such as a license plate illuminator (not shown), rear brake light 357, amber running or coasting light or turn signal light 351, or reverse drive light 208.

In a further embodiment, and with reference to FIG. 4D, an accelerator indicator 354 is mounted adjacent to, but separately from, a rear tail light assembly. In one embodiment, a rearward facing accelerator indicator 354 is engaged or illuminated when a driver engages or uses a reverse drive in a vehicle. In another variation, all accelerator 354 and brake indicators 351 are engaged or actuated when a driver engages or uses a reverse drive. Accelerator, coasting, turn, and brake indicators according to the present invention may also be mounted at one or more places along the side of a vehicle. FIG. 6 shows a side view of a vehicle. With reference to FIG. 6, accelerator, turning, coasting, and brake indicators may be mounted on the side region near the front region 701 of a vehicle, on the side mounted rearview mirror 720, on or near the door handle 710, or on the rear region 750 of a vehicle, or near the front 760 wheel well or near back the back wheel wall. These locations are provided for purposes of illustration and not limitation. Such indicators are comprised of a housing, at least one light bulb or other light emitting element, at least one socket, and are connected electrically to the electric system of the vehicle. Side, forward and rear accelerator indicators may be of any color.

With reference to FIG. 6A, an indicator unit 701 750 760 is comprised of a turn and coasting indicator 703, an accelerator indicator 705 and a brake indicator 708. An accelerator indicator 705 may be comprised of two light elements 707 which are capable of providing two or more stages of lighting such as a dim lighting state and a bright lighting state. In such an embodiment, one or more bulbs or lighting elements 707 are lit when the accelerator is engaged and the other element 707 is lit when the accelerator is not engaged. Alternatively, one single bulb or element may be manufactured so as to be emit light in varying states of intensity. In an alternative embodiment, one element 707 is lit when the accelerator is engaged and both elements 707 are lit when the accelerator is disengaged. One or more brake elements 709 are lit when the brake is engaged, and are not lit when the brake is disengaged. It should be noted that anytime the invention discusses a use or embodiment of one indicator light (e.g. dim and bright accelerator light) and/or a location of an indicator light (e.g., side-mounted indicator unit) it should be construed to include other indicator lights and other locations (e.g. dim and bright side mounted brake lights). Such specific examples are provided for purposes of illustration and not limitation.

FIG. 6D depicts an alternative indicator light embodiment wherein 3 color indicator unit and no lens covers the brake light 709, accelerator light 707 or turn light 703. Likewise, with reference to FIG. 6C, an indicator unit 710 is comprised as in FIG. 6A but is located near, or is part of, a door handle unit. In such an embodiment, a door handle 711, a key lock 712, an accelerator indicator 705 having one or more elements 707, a turn and/or coasting indicator 703 having one or more elements and a brake indicator 718 having one or more elements 719 comprise a door handle indicator unit. Such unit may have additional indicator functionality such as, but not limited to, illuminating or flashing one or more times upon receiving a signal from a keyless entry device, or illuminating or flashing continuously in a particular pattern upon receiving a signal from an auto theft detection component of the vehicle. Further, a door handle indicator unit may be illuminated continuously to facilitate entry into a vehicle. FIG. 6E depicts an alternative embodiment wherein an accelerator light colored lens 731, a brake light colored lens 733, and a turn light colored lens 735 covers colored or non-colored light sources. Such embodiment can be used in any light location including rearward facing lights, side-facing lights, etc.

With reference to FIG. 6B, a side indicator unit 720 is mounted to, and forms part of, a side mounted rearview mirror. Such a unit is comprised of an accelerator indicator 313, a turn and coasting indicator 310, and a brake indicator 315. Such a unit may have additional functionality such as, but not limited to, illuminating or flashing as a turn signal. In one embodiment, both an accelerator indicator 313 and a brake indicator 315 form a turn indicator, and illuminate or flash brightly upon an action taken by a vehicle driver indicating that the vehicle driver is turning in a particular direction. Again, all indicators, as part of such a side indicator unit 720, may have a dimly lit state and a brightly lit state as described previously. The turn indicator may be comprised of any number of colors, and may flash or illuminate in a variety of different patterns or modalities indicating a turn. In one embodiment, the indicator unit 720 curves around the sideview mirror so that the indicator lights can be viewed by following vehicles.

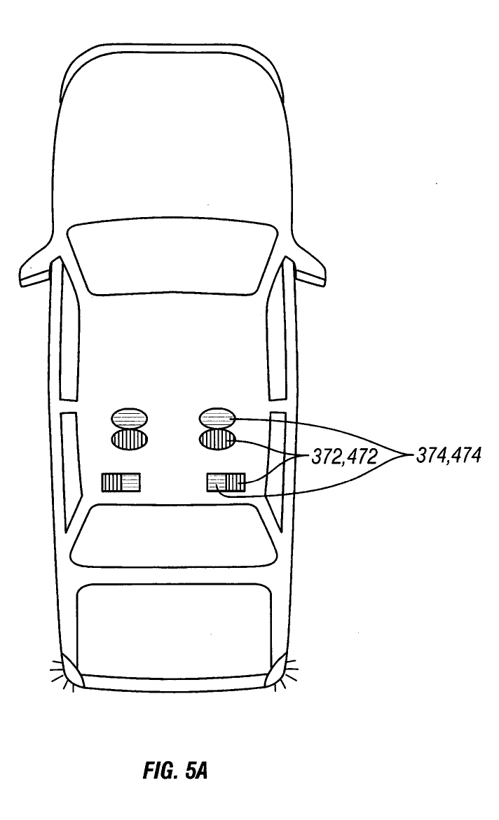

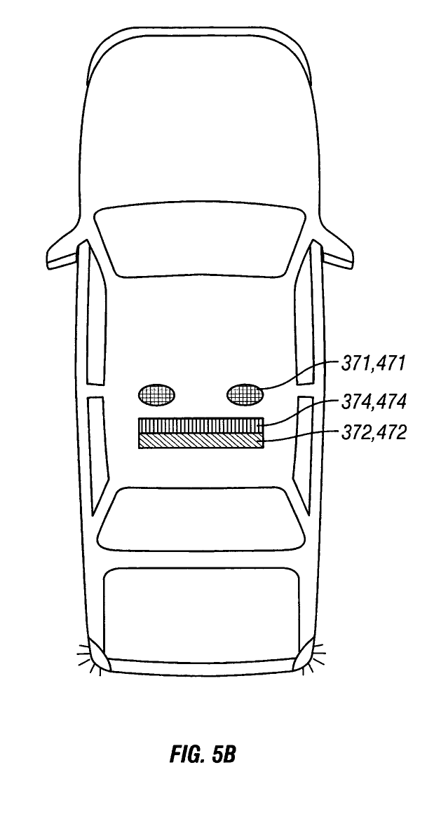

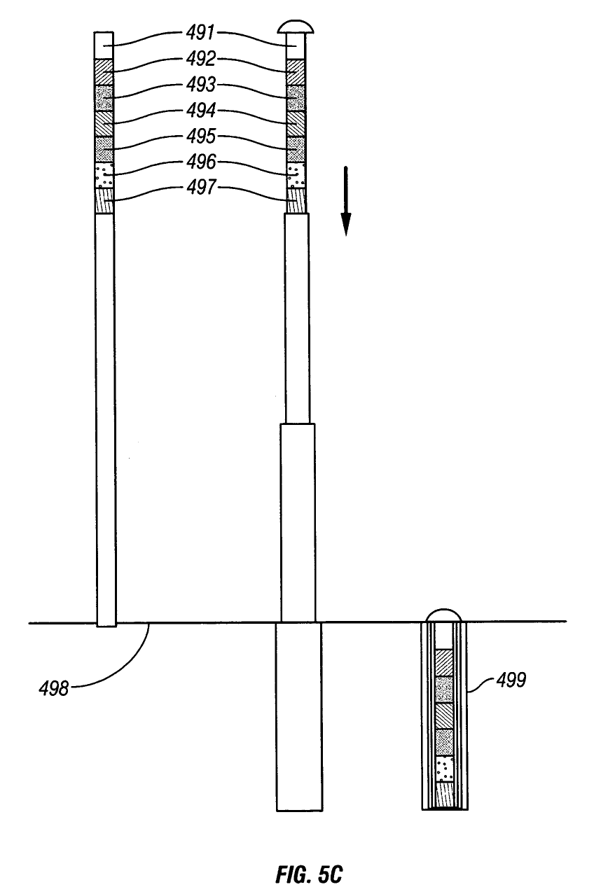

FIG. 5A-5B are top views of a vehicle depicting top facing lights in accordance with one embodiment of the present invention. Placement of a top facing brake light 374, top-facing accelerator light 372 and/or a top facing turn light 371 can be used to permit vehicles with an elevated driver, such as a bus or truck to more clearly see the lights. In one embodiment, an antenna having a brake light, accelerator light, turn light, and/or a coasting light can be placed on the vehicle. For example, FIG. 5C depicts a fixed mounted antenna on a vehicle surface 498 and a retractable, telescoping antennae in both the retracted 499 and protruding state in accordance with one embodiment of the present invention. The antennae can comprise a series of different colored lights 491 492 493 494 495 496 497. The antennae can be mounted anywhere on the car including the roof, trunk area, or hood-area. The antennae can have turn lights, coasting lights, brake lights, accelerator lights and emergency lights. The lights can have varying intensities and can flash. In one embodiment, the lights on the antennae can be controlled by a vehicle operator. Such control may be desirable to aid a following car in identifying a lead car. For example, a lead car having an antennae can initiate a blue light to permit a following car to easily track and see the lead car in heavy traffic. Such a guide light can result in additional road safety because following cars will not have to worry as much about tailing the lead car and the following car will be able to identify the lead car from several cars back. In one embodiment, the lights can be programmed to, for example, illuminate or flash the lights in a pattern upon the occurrence of some event, such as activating the lights from a keyless remote to help an operator find his or her vehicle in a crowded parking lot. In one embodiment, the lights are controlled by one or more sensors.

The indicator lights discussed above can be useful for clear weather conditions, adverse weather conditions, and in a warning system. The application of these lights to various driving conditions are discussed below.

Embodiments for Clear Driving Conditions

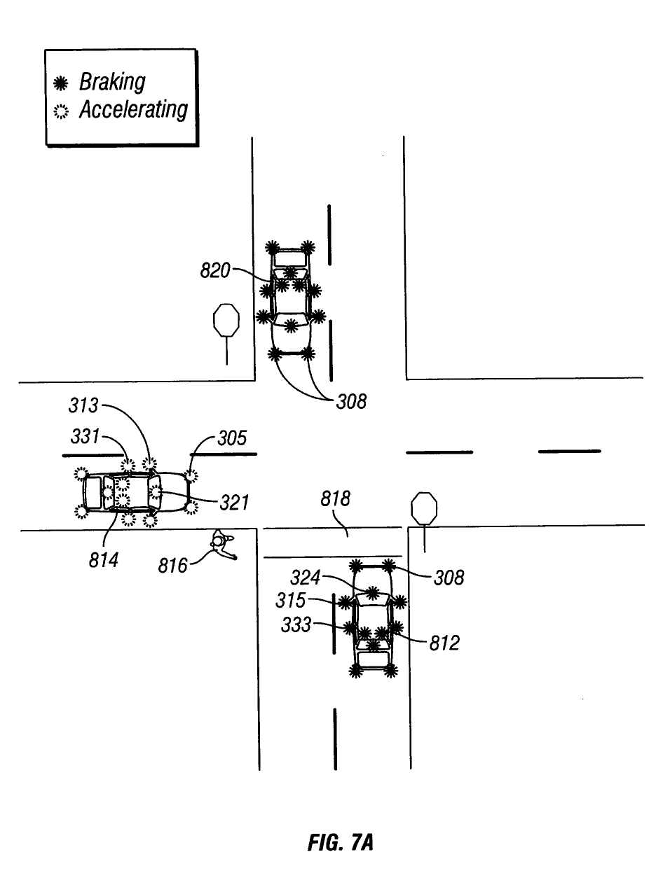

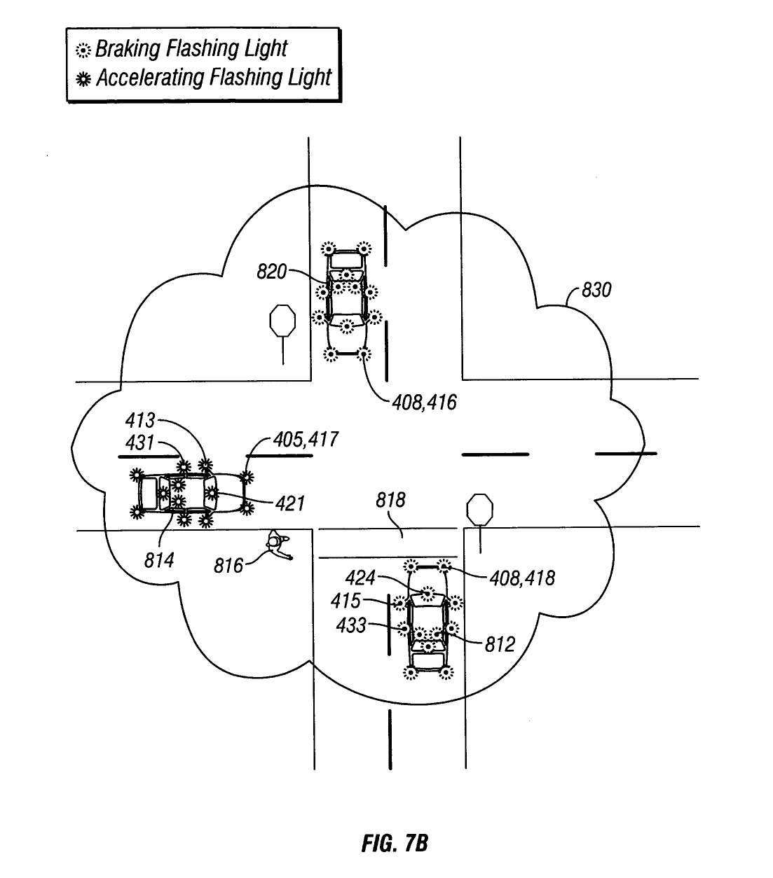

One set of benefits of improved accelerator and brake indicators can be seen by reference to a typical clear weather driving scenario as shown in FIG. 7A. With reference to FIG. 7A, two cars 812, 820 are stopped opposite each other at stop signs at a two-way stop, four-way intersection. The driver of vehicle 820 is able to see forward facing brake lights 308 on the car 812 across the intersection and forward facing accelerator lights 305 of the car on the driver's right 814. The approaching driver of vehicle 814 is able to see that the cars on the driver's right 812 and left 820 do not have the accelerators engaged and have the brakes engaged 308. The driver of the vehicle 812 is able to see forward facing accelerator lights 305 of the car on the driver's left, if the accelerator were engaged or coasting light (not shown) of the accelerator and the brake were not engaged. Either or both of the cars 812 820 were accelerating into the intersection, the driver of vehicle 814 would see the lack of forward facing brake lights 308 and would see forward facing accelerator lights 305 and could take appropriate action to avoid a collision.

Similarly, a pedestrian 816 waiting to cross the street in front of the stopped cars 812, 820 at stop signs in a crosswalk 818 would be able to verify that the stopped cars 812, 820 were actually stopped by seeing forward facing brake lights 308 and the lack of forward facing accelerator lights 305. A pedestrian 816 also would be able to determine that the driver of the approaching car 814 has not engaged the brakes by noticing the lack of forward facing brake lights 308 and would see a forward facing accelerator indicator 305, and in one embodiment a windshield mounted acceleration light 321.

Other indicators can also be used to aid conveyance of information regarding a vehicle's particular state. For example, vehicle 814 can include one or more door-mounted accelerator lights 331, side mirror mounted accelerator lights 313, and/or a windshield mounted accelerator light 321. Such examples are given for purposes of illustration and not limitation. Other locations (including rear window and top-facing) are shown and can be used. While numerous locations are depicted in the figures, it should be recognized that such locations are depicted for purposes of illustration and not limitation. It should be further noted that the like numerals represent like parts in the specification and numerals used in the figures may not always be explicitly referred to in the text accompanying the figure, however, one skilled in the art will recognize that the complete listing of reference numerals above in conjunction with the figures adequately discloses and enables one skilled in the art to practice the invention. Thus, it should be apparent that, for example, the side mirror mounted brake indicators 315 depicted on vehicle 812, need not be explicitly discussed to enable one skilled in the art to understand the meaning of the reference numeral. Similarly, where indicators are shown and not explicitly labeled by numeral, it is hereby asserted that one skilled in the art would understand the meaning of the symbol. For example, while no numeral explicitly references the side mirror mounted brake lights on vehicle 820, one skilled in the art looking at the figure can appreciate that such indicator is clearly depicted and any explanation would be unnecessary.

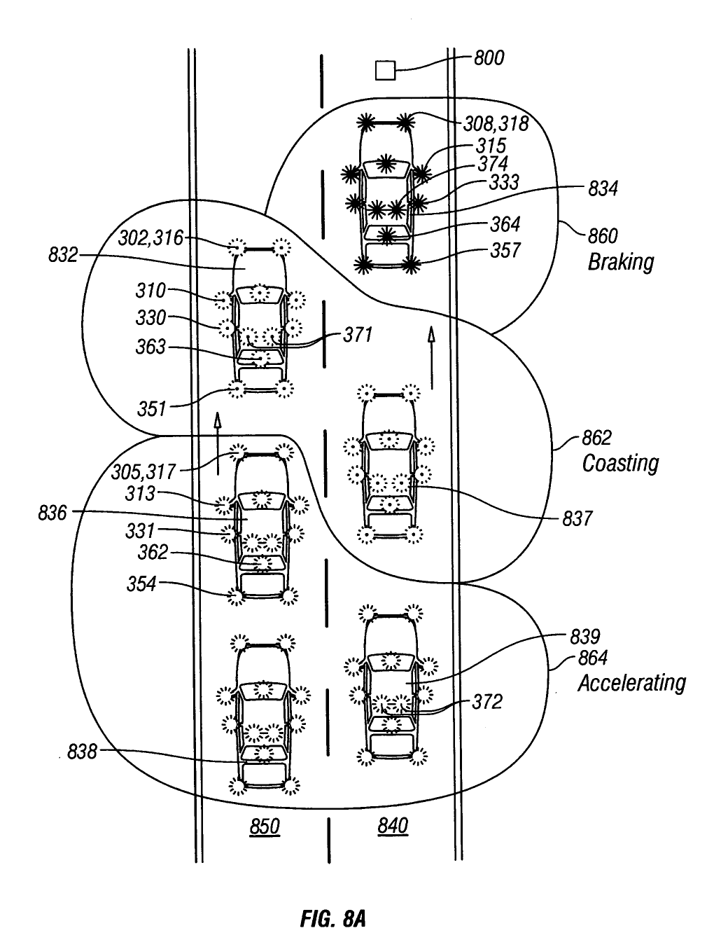

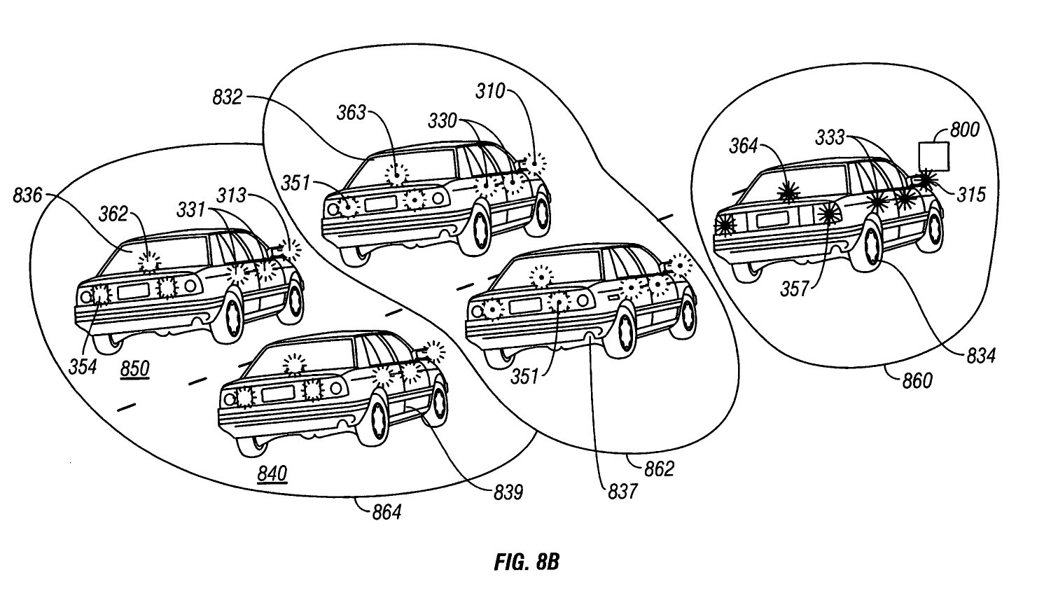

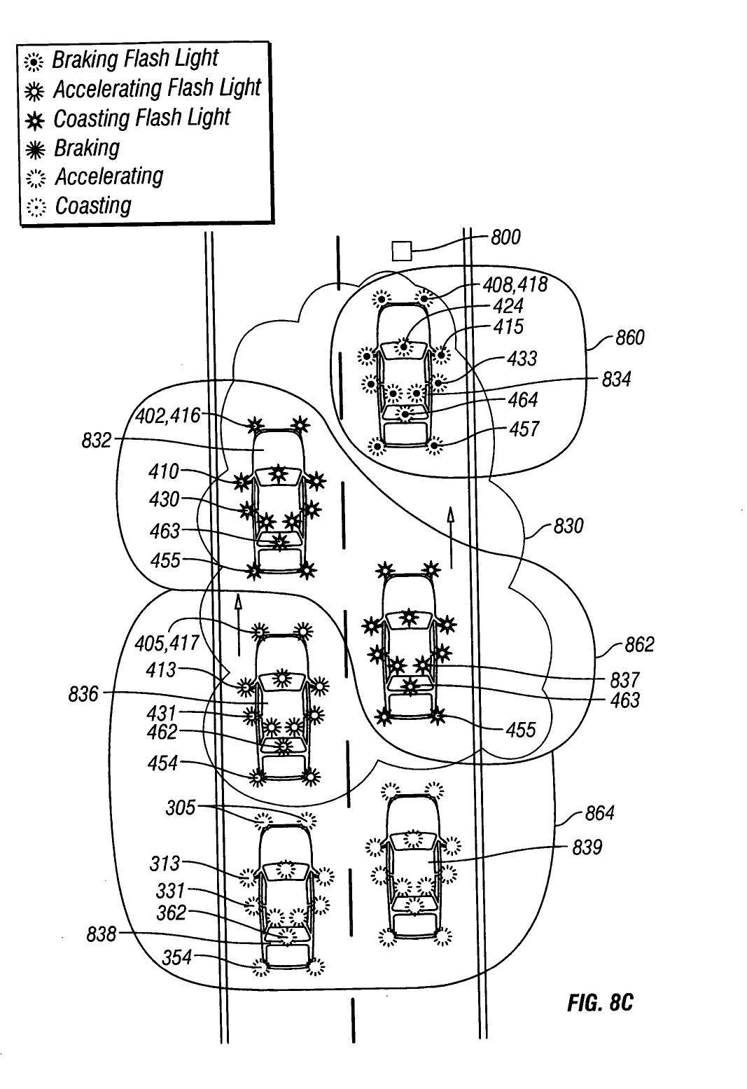

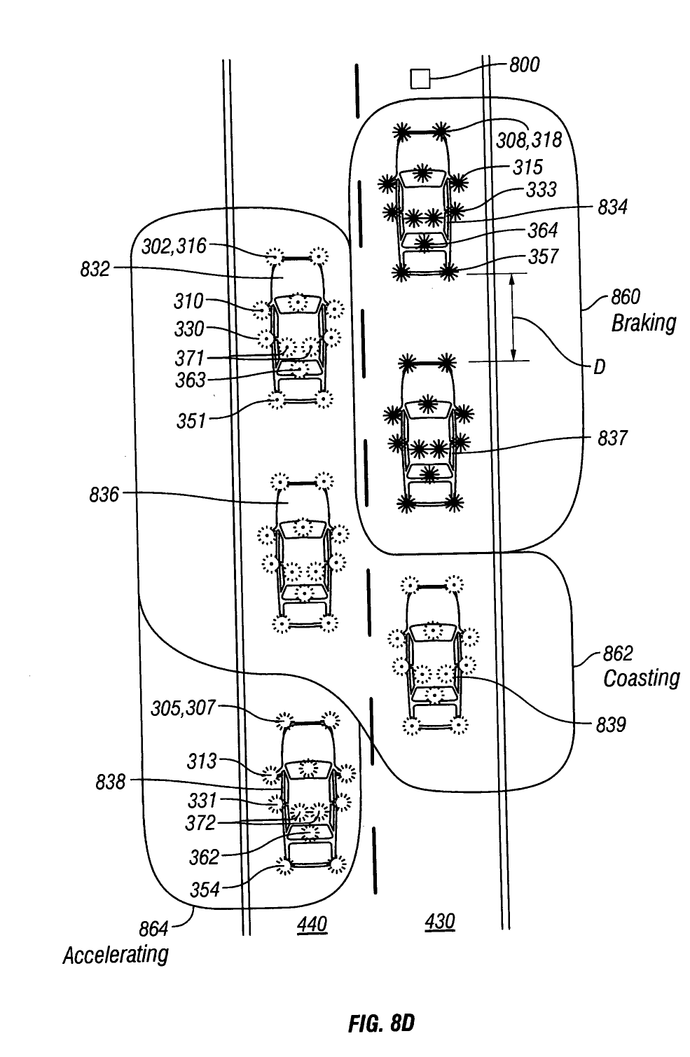

Additional benefits of improved brake, coasting, and accelerator indicators can be seen by reference to another typical, clear weather driving scenario as shown in FIG. 8A and FIG. 8B. Even though reference is made to “car”, a car may be any vehicle. In this scenario, there is a braking car 860, coasting cars 862, and accelerating cars 864. The lead car in the right lane 834 is decelerating by applying the vehicle's brakes, and is displaying illuminated brake lights through improved brake indicators mounted at the front 308, side 315 333, top 374 and rear 357 364 of the vehicle in response to an obstacle in the road 800. In a preferred embodiment, there is no use of accelerator lights when vehicle brakes are engaged.

The driver of the lead car 832 in the left lane 850, also seeing the obstacle 800 in the road, and seeing the improved indicator system including the rearward facing brake lights 357, side mirror mounted brake lights 315, door mounted brake lights 333, top facing brake lights 374, rear window mounted brake indicator 364, of the lead car 834 in the right lane 840, has already disengaged the accelerator and is watching for changing road conditions without applying the brakes. The lead car 832 in the left lane 850, while coasting without the use of the accelerator, is displaying one or more illuminated rearward facing coasting light indicators 351, side view mirror mounted coasting light indicators 310, front facing coasting light indicators 316, rear window coasting light indicators 363 and door mounted coasting light indicators 330. It should be pointed out that the coasting light indicators can be separate lights and colored different than the accelerator or brake lights or can merely be either the brake light or accelerator light operating at a different intensity, duration, color, or pattern than such lights operate in their respective accelerating or braking states.

With reference to FIG. 8B, an observer may be able to see side mounted rearview mirror accelerator light 313 coasting lights 310, or brake indicators 315 which are mounted to, or form part of, a rearview mirror on a side of a vehicle. In one embodiment, illuminated lights 310 330 363 351 are intensely or brightly lit in response to the driver disengaging the accelerator indicating that vehicle 832 is coasting. In another embodiment, such indicator 310, 330, 363, 351 are dimly or less brightly lit, or are not lit, when vehicle 832 is coasting. As used herein, coasting is defined as when neither the vehicle accelerator nor the vehicle brake is engaged.

Further, and with reference to FIG. 8A, the driver of the first following car 837 in the right lane 840, upon seeing the brake lights 315 333 357 364 of the leading car 834, disengages the accelerator. At this time, coasting indicator lights, which may be located on the front, sides and rear of the first following car 837, can be illuminated. Such change signals to all viewers that the first following car 837 in the right lane 840 could be transitioning to a braking state. Such advanced notice of potential braking by the first following car 837 would give all viewers more time in which to take corrective action. The driver of the first following car 836 in the left lane 850, without necessarily seeing the obstacle solely in the right lane 840, has improved information from the coasting light indicators 310 330 363 351, and brake light indicators 333 315 357 364 357 364 374 on the leading cars 832, 834 and the nearest adjacent car 837. Armed with this information, this driver perceives that perhaps he will not have to engage his brakes since the lead car 832 in the left lane 850 has not engaged his brakes, and perceives that just the right lane 840 is slowing. The driver of the first following car 836 in the left lane 850 thus has not disengaged the accelerator and has not engaged the brakes, and the accelerator lights 305 317 313 331 354 362 371 are thus illuminated.

With reference to FIG. 8A and FIG. 8B, the driver of the second following car 839 in the right lane 840 also has improved information from the four preceding cars 832 834 836 837. Specifically, the driver can perceive the light indicators of the two preceding cars 832 836 in the left lane 850 such that the leading car 832 is coasting and the first following car 836 is still using the accelerator. The indicators may be located on the front, sides, top, or rear sections of a vehicle. Also, this driver perceives that the leading car 834 in the right lane 840 is braking and the first following car 837 in the right lane 840 may be about to brake. Thus, this driver can perceive that the traffic in the right lane 840 is about to dramatically slow and that it may be preferable to transfer to the left lane 850 since the traffic in the left lane 850 is flowing more quickly.

Similarly, the driver of the second following car 838 shown in FIG. 8A (not shown in FIG. 8B) in the left lane 850 has improved information from the five preceding cars 832 834 836 837 839. Specifically, the driver can perceive the accelerator and coasting light indicators of the two preceding cars 832 836 in the left lane 850, and the braking, coasting, and accelerating lights of the three preceding cars 834 837 839 in the right lane 840. This driver perceives that the traffic in the right lane 840 is about to dramatically slow, and that it may be preferable to remain in the left lane 850 since the traffic in the left lane 850 is flowing more quickly. Additionally, the driver of the second following car 838 may decide to coast in response to the accelerator lights of the leading car 832. By perceiving how other drivers are using the accelerator, the driver of the second following car 838 has more information with which to make driving decisions and has more time in which to take corrective action.

Information from accelerator, brake, and coasting indicators allows drivers and observers to make more informed decisions. Such additional information from preceding cars provides an improved safety system for drivers in many driving scenarios including providing more response time in which to take corrective action due to changing road conditions including weather-related changes. Such improved information may save lives and reduce the number of vehicle accidents.

Such additional information allows drivers to coast instead of brake in certain driving scenarios. As measured over time, such additional information reduces the amount of stop and go operation of vehicles, reduces the amount of gasoline consumed in a single vehicle and collectively over all vehicles, reduces vehicle brake wear, and reduces the amount of exhaust released to the environment.

The Tables below illustrate the various permutations that can occur with various embodiments of the present invention. The first column, labeled “Case” depicts different scenarios. The second column, labeled “Brake,” indicates the status of the brake pedal, the third column, labeled, “Accelerator,” indicates the status of the accelerator pedal, and the fourth column, labeled, “Status,” indicates the status of the vehicle. The fifth column, labeled “Brake Indicator,” is based upon the vehicle status in column 4, and illustrates examples of the state of the brake indicators and the sixth column, labeled “Accelerator Indicator,” illustrates the state of the accelerator indicators.

Table 1A shows the status of the brake and accelerator indicators for a vehicle wherein a binary (on/off) indicator is used for both a brake indicator and an accelerator indicator. The first set of case scenarios (cases 0-1 to 0-4) summarizes the various signals that can be emitted based upon the status of the car—whether the car is coasting, braking, or accelerating, which can be determined from the state (engaged or disengaged) of the accelerator and brake pedals. For example, case 0-1 indicates that both the brake and accelerator are disengaged. Thus, the brake indicator can be either on or off in such status, as determined by a manufacturer and/or the operator of the vehicle. In case 1-1, the brake indicator is shown as in the “off” position, while in case 3-1, the brake indicator is shown as in the “on” position. Similarly, the accelerator indicator can be either on or off in such status, as determined by a manufacturer and/or the operator of the vehicle. Case 0-2 shows the brake as being engaged and the accelerator as disengaged meaning that the brake is engaged and the car is braking. Thus, the brake indicator is shown as “on” and the accelerator indicator is shown as “off.” Case 0-3 shows the accelerator as being engaged and the brake as disengaged meaning that the accelerator is engaged and the car is accelerating. Thus, the accelerator indicator is shown as “on” and the accelerator indicator is shown as “off.”

A special fourth 0-4 case is also indicated. The special fourth case can be directed to an emergency status (e.g. where both brake and accelerator are engaged; such case can occur in manual transmission cars when an operator is engaging both the accelerator and the brake at the same time), a guide light embodiment, or in an embodiment in which one is trying to locate a vehicle in a crowded parking lot, and all permutations are possible.

TABLE 1A
One Level of Brake Indicator and One Level of Accelerator Indicator
Safety Signaling System Depicting Alternative Modes of Operation
of Improved Accelerator and
Brake Indicators For Clear Driving Conditions

| | | | | | Accelerator |
|---|---|---|---|---|---|
| Case | Brake | Accelerator | Status | Brake Indicator | Indicator |
| 0-1 | Disengaged | Disengaged | Coasting | Off, On | Off, On |
| 0-2 | Engaged | Disengaged | Braking | On | Off |
| 0-3 | Disengaged | Engaged | Accelerating | Off | On |
| 0-4 | Engaged | Engaged | Special case | Off, On(Blinking) | Off, On(Blinking) |
| 1-1 | Disengaged | Disengaged | Coasting | Off | Off |
| 1-2 | Engaged | Disengaged | Braking | On | Off |
| 1-3 | Disengaged | Engaged | Accelerating | Off | On |
| 2-1 | Disengaged | Disengaged | Coasting | Off | On |
| 2-2 | Engaged | Disengaged | Braking | On | Off |
| 2-3 | Disengaged | Engaged | Accelerating | Off | On |
| 3-1 | Disengaged | Disengaged | Coasting | On | On |
| 3-2 | Engaged | Disengaged | Braking | On | Off |
| 3-3 | Disengaged | Engaged | Accelerating | Off | On |
| 4-1 | Disengaged | Disengaged | Coasting | On | Off |
| 4-2 | Engaged | Disengaged | Braking | On | Off |
| 4-3 | Disengaged | Engaged | Accelerating | Off | On |

Table 2A illustrates several various alternative modes of operation of improved accelerator and brake indicators according to the present invention. Table 2A shows the status of brake and accelerator indicators for a vehicle wherein a binary or on/off indicator is used for the brake indicator and a two level indicator is used for the accelerator indicator. Like Table 1A above, Table 2A comprises a summary table followed by more specific scenarios. With reference to Table 2A, in case 0-1, an accelerator indicator may be off, illuminating at a first intensity or level (level 1), or illuminating at a second level (level 2). The intensities are different; in one embodiment, level 1 is less intense than level 2 and in another embodiment, level 1 is more intense than level 2. In case 0-2, a braking indicator is illuminated when a vehicle's brake is engaged. In case 0-3, when a vehicle's accelerator is engaged, an accelerator indicator may be illuminating at a first intensity or level (level 1), or illuminating at a second level (level 2). In case 0-4, a brake indicator is illuminated and an accelerator indicator may be in any of the states. In another embodiment, discussed in more detail with reference to Table 2A, an accelerator indicator may also illuminate at a first and a second intensity or level.

Such modes in Table 2A illustrate that an observer is likely to notice a transition from one state of an indicator to another. For example, for an operator who disengages the accelerator, an observer is likely to see a change in accelerator indicator intensity, such as, but not limited to, the accelerator indicator going from level 2 to level 1.

TABLE 2A
One Level of Brake Indicator and Two Levels of Accelerator Indicator

| | | | | Brake | Accelerator |
|---|---|---|---|---|---|
| Case | Brake | Accelerator | Status | Indicator | Indicator |
| 0-1 | Disengaged | Disengaged | Coasting | Off, On | Off, Level 1, Level 2 |
| 0-2 | Engaged | Disengaged | Braking | On | Off, Level 1, Level 2 |
| 0-3 | Disengaged | Engaged | Accelerating | Off | Level 1, Level 2 |
| 0-4 | Engaged | Engaged | Special Case | Off, On(Blinking) | Off, Level 1, Level |
| | | | | | 2(Blinking) |
| 1-1 | Disengaged | Disengaged | Coasting | Off | Level 1 |
| 1-2 | Engaged | Disengaged | Braking | On | Off |
| 1-3 | Disengaged | Engaged | Accelerating | Off | Level 2 |
| 2-1 | Disengaged | Disengaged | Coasting | On | Off |
| 2-2 | Engaged | Disengaged | Braking | On | Off |
| 2-3 | Disengaged | Engaged | Accelerating | Off | Level 2 |
| 3-1 | Disengaged | Disengaged | Coasting | On | Level 1 |
| 3-2 | Engaged | Disengaged | Braking | On | Off |
| 3-3 | Disengaged | Engaged | Accelerating | Off | Level 2 |
| 4-1 | Disengaged | Disengaged | Coasting | On | Off |
| 4-2 | Engaged | Disengaged | Braking | On | Level 1 |
| 4-3 | Disengaged | Engaged | Accelerating | Off | Level 2 |
| 5-1 | Disengaged | Disengaged | Coasting | Off | Off |
| 5-2 | Engaged | Disengaged | Braking | On | Level 1 |
| 5-3 | Disengaged | Engaged | Accelerating | Off | Level 2 |

Likewise, for a brake having two levels of illumination, there are many more permutations of illumination of a brake indicator in combination with an accelerator indicator. The remaining sets of case scenarios shown in Tables 3A and 4A are based upon the summary set of scenarios and are self-explanatory.

Table 3A shows the status of brake and accelerator indicators for a vehicle wherein a two level indicator is used for the brake indicator and a binary or on/off indicator is used for the accelerator indicator.

TABLE 3A
Two Levels of Brake Indicator and One Level of Accelerator Indicator

| | | | | | Accelerator |
|---|---|---|---|---|---|
| Case | Brake | Accelerator | Status | Brake Indicator | Indicator |
| 0-1 | Disengaged | Disengaged | Coasting | Off, Level 1 | Off, On |
| 0-2 | Engaged | Disengaged | Braking | Level 2 | Off |
| 0-3 | Disengaged | Engaged | Accelerating | Off, Level 1 | On |
| 0-4 | Engaged | Engaged | Special Case | Level 1, | Off, On(Blinking) |
| | | | | Level | |
| | | | | 2(Blinking) | |
| 1-1 | Disengaged | Disengaged | Coasting | Level 1 | Off |
| 1-2 | Engaged | Disengaged | Braking | Level 2 | Off |
| 1-3 | Disengaged | Engaged | Accelerating | Level 1 | On |
| 2-1 | Disengaged | Disengaged | Coasting | Level 1 | Off |
| 2-2 | Engaged | Disengaged | Braking | Level 2 | Off |
| 2-3 | Disengaged | Engaged | Accelerating | Off | On |
| 3-1 | Disengaged | Disengaged | Coasting | Level 1 | On |
| 3-2 | Engaged | Disengaged | Braking | Level 2 | Off |
| 3-3 | Disengaged | Engaged | Accelerating | Level 1 | On |
| 4-1 | Disengaged | Disengaged | Coasting | Off | On |
| 4-2 | Engaged | Disengaged | Braking | Level 2 | Off |
| 4-3 | Disengaged | Engaged | Accelerating | Level 1 | On |
| 5-1 | Disengaged | Disengaged | Coasting | Off | Off |
| 5-2 | Engaged | Disengaged | Braking | Level 2 | Off |
| 5-3 | Disengaged | Engaged | Accelerating | Level 1 | On |
| 6-1 | Disengaged | Disengaged | Coasting | Level 1 | On |
| 6-2 | Engaged | Disengaged | Braking | Level 2 | Off |
| 6-3 | Disengaged | Engaged | Accelerating | Off | On |

Table 4A shows the status of brake and accelerator indicators for a vehicle wherein a two level indicator is used for the brake indicator and a two level indicator is used for the accelerator indicator.

TABLE 4A
Two Levels of Brake Indicator and Two Levels of Accelerator Indicator

| | | | | Brake | Accelerator |
|---|---|---|---|---|---|
| Case | Brake | Accelerator | Status | Indicator | Indicator |
| 0-1 | Disengaged | Disengaged | Coasting | Off, Level 1, | Off, Level 1, Level 2 |
| | | | | Level 2 | |
| 0-2 | Engaged | Disengaged | Braking | Level 2 | Off, Level 1, Level 2 |
| 0-3 | Disengaged | Engaged | Accelerating | Off, Level 1, | Level 1, Level 2 |
| 0-4 | Engaged | Engaged | Special Case | Off, Level 1, | Off, Level 1, Level 2 |
| | | | | Level 2 | (Blinking) |
| | | | | (Blinking) | |
| 1-1 | Disengaged | Disengaged | Coasting | Off | Level 1 |
| 1-2 | Engaged | Disengaged | Braking | Level 2 | Off |
| 1-3 | Disengaged | Engaged | Accelerating | Off | Level 2 |
| 2-1 | Disengaged | Disengaged | Coasting | Off | Level 2 |
| 2-2 | Engaged | Disengaged | Braking | Level 2 | Off |
| 2-3 | Disengaged | Engaged | Accelerating | Off | Level 1 |
| 3-1 | Disengaged | Disengaged | Coasting | Level 1 | Level 1 |
| 3-2 | Engaged | Disengaged | Braking | Level 2 | Level 1 |
| 3-3 | Disengaged | Engaged | Accelerating | Off | Level 2 |
| 4-1 | Disengaged | Disengaged | Coasting | Level 1 | Level 2 |
| 4-2 | Engaged | Disengaged | Braking | Level 2 | Level 2 |
| 4-3 | Disengaged | Engaged | Accelerating | Off | Level 1 |
| 5-1 | Disengaged | Disengaged | Coasting | Level 1 | Off |
| 5-2 | Engaged | Disengaged | Braking | Level 2 | Level 1 |
| 5-3 | Disengaged | Engaged | Accelerating | Off | Level 2 |
| 6-1 | Disengaged | Disengaged | Coasting | Off | Level 2 |
| 6-2 | Engaged | Disengaged | Braking | Level 2 | Off |
| 6-3 | Disengaged | Engaged | Accelerating | Level 1, | Level 1 |
| 7-1 | Disengaged | Disengaged | Coasting | Level 1 | Level 1 |
| 7-2 | Engaged | Disengaged | Braking | Level 2 | Off |
| 7-3 | Disengaged | Engaged | Accelerating | Level 1 | Level 2 |
| 8-1 | Disengaged | Disengaged | Coasting | Level 1 | Level 1 |
| 8-2 | Engaged | Disengaged | Braking | Level 2 | Level 1 |
| 8-3 | Disengaged | Engaged | Accelerating | Level 1 | Level 2 |
| 9-1 | Disengaged | Disengaged | Coasting | Level 1 | Level 2 |
| 9-2 | Engaged | Disengaged | Braking | Level 2 | Off |
| 9-3 | Disengaged | Engaged | Accelerating | Level 1 | Level 1 |
| 10-1 | Disengaged | Disengaged | Coasting | Level 1 | Level 2 |
| 10-2 | Engaged | Disengaged | Braking | Level 2 | Level 2 |
| 10-3 | Disengaged | Engaged | Accelerating | Level 1 | Level 1 |

Embodiments for Adverse Driving Conditions

FIG. 7B provides a top view of several cars convening at an intersection where there is reduced visibility due to fog 830. A first car 812 approaches a stop sign and prepares to yield. It is urgent that the first car 812 or third car 820 be aware of oncoming second car 814. It is also urgent for a pedestrian 816 to appreciate the danger of entering the intersection. The use of pulsing or flashing lights in accordance with the present invention would improve the safety of the entire situation. For example, the car 814 can have front facing flashing accelerator lights 405 417 door mounted flashing accelerator lights 431, side mirror mounted flashing accelerator lights 413, and/or windshield mounted flashing accelerator lights 421. Hence, the present invention can provide a first signaling system during clear weather conditions as depicted in FIG. 7A and a second signaling system during more dangerous driving conditions, such as reduced visibility conditions as depicted in FIG. 7B.

A more dangerous or adverse driving condition can also occur in clear weather in a hard braking scenario, discussed in more detail below. In one embodiment, the operator manually changes between the first signaling system and the second signaling system and in one embodiment, the change is triggered automatically based upon weather or the predetermined degree of hard braking.

In one embodiment, the first signaling system uses lights in the on and off state and the second signaling system uses strobe lights in a flashing or pulsing state. Similarly the second car 814 depicted in FIG. 7B is able to see, through the fog, the flashing brake indicator lights 408 416 424 415 433 of the second car 812 and third car 820 and can watch for any change in these lights and take appropriate action. Further, if the accelerator indicator lights 405 417 412 421 are of a different color, e.g. blue, than the brake indicator lights 408 416 424 415 433, it may be easier for a pedestrian and other operators to ascertain, recognize, and react to the status of a vehicle.

FIG. 8C illustrates a number of cars that are traveling on a road. Visibility is partially obscured by fog 830. The fog will make it difficult under normal circumstances for vehicle 837 to see that vehicle 834 is braking to avoid an object 800. In one embodiment, the fog triggers flashing indicators for braking, coasting, and accelerating. In one embodiment, when a vehicle is braking hard, flashing brake indicators are triggered. Even if the driver of vehicle 837 sees red lights ahead of him, he may not be able to easily distinguish between normal coasting light intensity and brake light intensity. This is why fog and other reduced visibility situations are responsible for so many traffic accidents and fatalities. Hence, one advantage of the present invention is that by having a flashing accelerator light or flashing coasting light that is different from a brake light, greater safety can be achieved. Further, if the first vehicle 834 had flashing brake lights 408 418 424 433 415 464 457, it is far more likely that the second vehicle 837 would recognize that it also needed to brake to avoid a collision. A trailing car 837 in the fog is not the only vehicle that would benefit from a more conspicuous warning. Car 839 will benefit if second vehicle 837 also has flashing coasting lights 455 463. Likewise, vehicle 836 would benefit from the flashing of side mounted and rearward facing lights.

With reference to FIG. 3A, a lower front facing flashing brake indicator 418, a lower front facing flashing coasting light 416 and a lower front facing flashing accelerator light 417 can be provided either as additional, separate electrical sockets within a conventional headlamp with or without a headlamp enclosure. Similarly, the door mounted flashing coasting light 430, door mounted flashing brake light 433, and door mounted accelerator flashing lights 431 can be provided as additional, separate electrical sockets within the enclosure with their non-flashing counterparts. Alternatively, a portion of all of the vehicle indicators can be configured to function as either flashing or non-flashing indicators.

Table 1B shows a safety signaling system depicting alternative modes of operation of improved accelerator and brake indicators during adverse driving conditions. Only brake lights are programmed to flash during braking and only the accelerator lights are programmed to flash during acceleration. Like the clear weather embodiment, flashing lights can be provided with two levels of illumination. Thus, there are many permutations of illumination of a brake indicator in combination with an accelerator indicator, coasting indicator, and/or turn indicator. Case 1 in Table 1B below, depicts a summary of several modes of operation. Such conditions can result from inclement weather, reduced visibility, or in a situation where a collision is imminent. Referring to the first row under the heading, when the brake and accelerator pedals are disengaged, the car is coasting. This can be communicated by having the brake and/or accelerator lights off, flashing at a first intensity, level, pattern, or color, or flashing at a second intensity, level, pattern, or color. Similarly, when the brake is engaged and the accelerator is disengaged, the car is braking. This vehicle status can be communicated by having the brake lights flashing at second intensity, level, pattern, or color, and having the accelerator lights off or flashing at a first intensity, level, pattern or color. The third row in the table depicts the brake disengaged, the accelerator engaged indicating the car is accelerating. This vehicle status can be communicated by having the brake lights off or flashing at a first intensity and having the accelerator lights flashing at a first or second intensity. The fourth row in the table depicts both the accelerator and brake engaged. In such an embodiment, all permutations are possible.

TABLE 1B
Safety Signaling System Depicting Alternative Modes of Operation of
Improved Brake Indicator and Accelerator Indicator

| | | | | |
|---|---|---|---|---|
| Brake | Accelerator | Status | Brake lights | Accelerator lights |

Case 1 - Summary

| | | | | |
|---|---|---|---|---|
| Disengaged | Disengaged | Coasting | Off, Flashing | Off, Flashing Level 1, |
| | | | Level 1, Flashing | Flashing Level 2 |
| | | | Level 2 | |
| Engaged | Disengaged | Braking | Flashing Level 2 | Off, Flashing Level 1, |
| | | | | Flashing Level 2 |
| Disengaged | Engaged | Accelerating | Off, Flashing | Flashing Level 1, |
| | | | Level 1 | Flashing Level 2 |
| Engaged | Engaged | Accelerating | Off, Flashing | Off, Flashing Level 1, |
| | | | Level 1, Flashing | Flashing Level 2 |
| | | | Level 2 | |

Case 2

| | | | | |
|---|---|---|---|---|
| Disengaged | Disengaged | Coasting | Flashing | Flashing |
| Engaged | Disengaged | Braking | Flashing | Off |
| Disengaged | Engaged | Accelerating | Off | Flashing |

Case 3

| | | | | |
|---|---|---|---|---|
| Disengaged | Disengaged | Coasting | Flashing | Off |
| Engaged | Disengaged | Braking | Flashing | Off |
| Disengaged | Engaged | Accelerating | Off | Flashing |

Case 4

| | | | | |
|---|---|---|---|---|
| Disengaged | Disengaged | Coasting | Off | Flashing |
| Engaged | Disengaged | Braking | Flashing | Off |
| Disengaged | Engaged | Accelerating | Off | Flashing |

Case 5

| | | | | |
|---|---|---|---|---|
| Disengaged | Disengaged | Coasting | Off | Flashing |
| Engaged | Disengaged | Braking | Flashing | Flashing |
| Disengaged | Engaged | Accelerating | Off | Flashing |

Case 6

| | | | | |
|---|---|---|---|---|
| Disengaged | Disengaged | Coasting | Flashing | Off |
| Engaged | Disengaged | Braking | Flashing | Flashing |
| Disengaged | Engaged | Accelerating | Off | Flashing |

Further, in addition to the accelerator and brake indicator embodiments, the system can also be utilized to improve the visibility of turn indicators, as depicted in Table 2B, below:

TABLE 2B
Safety Signaling System Depicting Alternative Modes of Operation
of Improved Turn Signal Indicators.

| | Embodiment #1 | Embodiment #2 | Embodiment #3 |
|---|---|---|---|
| | Right signal/ | Right signal/ | Right signal/ |
| Direction | left signal | Left signal | Left signal |
| Right turn | 3x/1x | 1x/0x | Both, then right only |
| Left turn | 1x/3x | 0x/1x | Both, then left only |

As depicted by Table 2B, in one embodiment one signal flashes some multiple times faster than the other signal. In a second embodiment, only one signal flashes. In a third embodiment, turn indicators located on both sides of the vehicle can be flashed, followed by the flashing of the turn indicator for the direction of the turn. In one embodiment, the turn indicator is the indicator not in use. For example, if the vehicle is accelerating and the turn signal is operated, the brake indicator flashes to indicate the direction of turn. Similarly, if the vehicle is braking and the turn signal is operated, the accelerator indicator flashes to indicate the direction of turn.

As mentioned above, the brake or accelerator or a third light can be used as turning lights. For purposes of the charts below the mark * means a single flash and *** means multiple flashing. Table 1B1, below, depicts an example of how Case 4 from Table 1B can be applied in one embodiment of the present invention.

TABLE 1B1
Safety Signaling System Depicting Alternative Modes of Operation of Improved
Accelerator Light Used as Turn Signal Indicators

| Status | Indicators | Brake lights | Accelerator lights |
|---|---|---|---|
| Emergency | Right indicators | *** *** *** | *** *** *** |
| | Left indicators | *** *** *** | *** *** *** |
| Coasting | Right indicators | | * * * * * * |
| | Left indicators | | * * * * * * |
| Coasting & | Right indicators | | *** *** *** |
| Right turn | Left indicators | | * * * * * * |
| Coasting & | Right indicators | | * * * * * * |
| Left turn | Left indicators | | *** *** *** |
| Braking | Right indicators | * * * * * * | |
| | Left indicators | * * * * * * | |
| Braking & | Right indicators | * * * * * * | *** *** *** |
| Right turn | Left indicators | * * * * * * | |
| Braking & | Right indicators | * * * * * * | |
| Left turn | Left indicators | * * * * * * | *** *** *** |
| Sudden Stop or | Right indicators | *** *** *** * * * * | |
| Full Stop | Left indicators | *** *** *** * * * * | |
| Sudden braking & Right turn | Right indicators | *** *** *** * * * * | *** *** *** *** |
| or Full Stopping & Right turn | | | *** |
| | Left indicators | *** *** *** * * * * | |
| Sudden braking & Left turn | Right indicators | *** *** *** * * * * | |
| or Full Stopping & Left | Left indicators | *** *** *** * * * * | *** *** *** *** |
| turn | | | *** |
| Accelerating | Right indicators | | * * * * * |
| | Left indicators | | * * * * * |
| Accelerating & Right | Right indicators | | *** *** *** |
| turn | Left indicators | | * * * * * |
| Accelerating& Left turn | Right indicators | | * * * * * |
| | Left indicators | | *** *** *** |

Table 1B2, below, depicts an example of how Case 4 from Table 1B can be applied in one embodiment of the present invention.

TABLE 1B2
Safety Signaling System Depicting Alternative Modes of Operation of Improved
Brake Light Used as Turn Signal Indicator

| Status | Indicators | Brake lights | Accelerator lights |
|---|---|---|---|
| Emergency | Right indicators | *** *** *** | *** *** *** |
| | Left indicators | *** *** *** | *** *** *** |
| Coasting | Right indicators | | * * * * * * |
| | Left indicators | | * * * * * * |
| Coasting & Right turn | Right indicators | *** *** *** | * * * * * * |
| | Left indicators | | * * * * * * |
| Coasting & Left turn | Right indicators | | * * * * * * |
| | Left indicators | *** *** *** | * * * * * * |
| Braking | Right indicators | * * * * * * | |
| | Left indicators | * * * * * * | |
| Braking & Right turn | Right indicators | *** *** *** | |
| | Left indicators | * * * * * * | |
| Braking & Left turn | Right indicators | * * * * * * | |
| | Left indicators | *** *** *** | |
| Sudden Braking or Full | Right indicators | *** *** *** * * * * | |
| Stop | Left indicators | *** *** *** * * * * | |
| Sudden Braking & Right turn | Right indicators | *** *** *** *** *** *** | |
| or Full Stopping & Right turn | Left indicators | *** *** *** * * * * | |
| Sudden Braking & Left turn | Right indicators | *** *** *** * * * * | |
| or Full Stopping & Left | Left indicators | *** *** *** *** *** *** | |
| turn | | | |
| Accelerating | Right indicators | | * * * * * * |
| | Left indicators | | * * * * * * |
| Accelerating | Right indicators | *** *** *** | * * * * * * |
| & Right turn | Left indicators | | * * * * * * |
| Accelerating | Right indicators | | * * * * * * |
| & Left turn | Left indicators | *** *** *** | * * * * * * |

Table 1B3, below, depicts an example of a two color embodiment of the present invention.

TABLE 1B3
Safety Signaling System Depicting Alternative Modes of Operation of
Improved Indicator Light as Turn Signal Indicator

| | | | Accelerator |
|---|---|---|---|
| Status | Indicators | Brake lights | lights |
| Coasting | Right indicators | * * * * | |
| | Left indicators | * * * * | |
| Coasting & Right turn | Right indicators | * * * * | *** *** *** |
| | Left indicators | * * * * | |
| Coasting & Left turn | Right indicators | * * * * | |
| | Left indicators | * * * * | *** *** *** |
| Braking | Right indicators | * * * * * * | |
| | Left indicators | * * * * * * | |
| Braking & Right turn | Right indicators | | *** *** *** |
| | Left indicators | * * * * * * | |
| Braking & Left turn | Right indicators | * * * * * * | |
| | Left indicators | | *** *** *** |
| Accelerating | Right indicators | | * * * * * * |
| | Left indicators | | * * * * * * |
| Accelerating | Right indicators | *** *** *** | * * * * * * |
| & Right turn | Left indicators | | * * * * * * |
| Accelerating | Right indicators | | * * * * * * |
| & Left turn | Left indicators | *** *** *** | * * * * * * |

TABLE 1B4
Safety Signaling System Depicting Alternative Modes of Operation of Improved Turn
Light Used as Turn Light Indicators (Turn lights = Amber or other color)

| Status | Indicators | Brake lights | Accelerator lights | Turn lights |
|---|---|---|---|---|
| Emergency I | Right indicators | *** *** *** | *** *** *** | |
| | Right turn | | | |
| | Left indicators | *** *** *** | *** *** *** | |
| | Right turn | | | |
| Emergency II | Right indicators | *** *** *** | *** *** *** | |
| | Right turn | | | *** *** *** |
| | Left indicators | *** *** *** | *** *** *** | |
| | Right turn | | | *** *** *** |
| Coasting | Right indicators | | * * * * * | |
| | Right turn | | | |
| | Left indicators | | * * * * * | |
| | Right turn | | | |
| Coasting & | Right indicators | | * * * * * | |
| Right turn | Right turn | | | *** *** *** |
| | Left indicators | | * * * * * | |
| | Left turn | | | |
| Coasting & | Right indicators | | * * * * * | |
| Left turn | Right turn | | | |
| | Left indicators | | * * * * * | |
| | Left turn | | | *** *** *** |
| Braking | Right indicators | * * * * * | | |
| | Right turn | | | |
| | Left indicators | * * * * * | | |
| | Right turn | | | |
| Braking & | Right indicators | * * * * * | | |
| Right turn | Right turn | | | *** *** *** |
| | Left indicators | * * * * * | | |
| | Left turn | | | |
| Braking & | Right indicators | * * * * * | | |
| Left turn | Right turn | | | |
| | Left indicators | * * * * * | | |
| | Left turn | | | *** *** *** |
| Sudden | Right indicators | *** *** *** * * * * | | |
| Braking or | Right turn | | | |
| Full Stop | Left indicators | *** *** *** * * * * | | |
| | Right turn | | | |
| Sudden Braking & | Right indicators | *** *** *** * * * * | | |
| Right turn | Right turn | | | *** *** *** *** |
| or Full Stop & | Left indicators | *** *** *** * * * * | | |
| Right turn | Left turn | | | |
| Sudden Braking & | Right indicators | *** *** *** * * * * | | |
| Left turn | Right turn | | | |
| or Full Stop & | Left indicators | *** *** *** * * * * | | |
| Left turn | Left turn | | | *** *** *** *** |
| Accelerating | Right indicators | | * * * * | |
| | Right turn | | | |
| | Left indicators | | * * * * | |
| | Right turn | | | |
| Accelerating & | Right indicators | | * * * * | |
| Right turn | Right turn | | | *** *** *** |
| | Left indicators | | * * * * | |
| | Left turn | | | |
| Accelerating & | Right indicators | | * * * * | |
| Left turn | Right turn | | | |
| | Left indicators | | * * * * | |
| | Left turn | | | *** *** *** |

The above tables and scenarios are provided solely for purposes of illustration and not for purposes of limitation. Now that the use of flashing for braking, accelerating, coasting, and turning has been discussed, it is important to understand the methods of enhancing the flashing to improve visibility further: with intensity, rate, length, color change, pattern, and combinations thereof.

Table 3B depicts a summary of some of the ways the various signal indicators can change based upon variables including the speed of the vehicle and weather conditions. For example, the accelerator indicators can have varying lengths of time based upon weather. If the weather is relatively good (e.g. light fog or rain) and considered “0” on a scale of 0 to 7, with 7 indicating severe inclement weather with poor visibility, then the accelerator light may only be on for a relatively short period of time and/or may be flashed or illuminated at the lowest intensity indicated by the single asterisk *. On the other hand, if the weather is bad (e.g. heavy fog or rain) and the weather is considered “7” on a scale of 0 to 7, then the accelerator light may be on for a longer period of time, and/or may be flashed or illuminated at the highest intensity indicated by set of seven asterisks *******. Further, for relatively light rain or light fog, the weather may only be considered “4” and the accelerator light would then be on for a period of time and/or may be flashed or illuminated to a medium intensity as indicated by four asterisks ****. Thus, the length or intensity that the accelerator indicators are flashed or illuminated can thereby be automatically tied to the degree of weather.

In the same manner as discussed above with respect to the length of an accelerator flashing, the interval of flashing, color of flashing, and degree of brightness can also be adjusted based upon the degree of adverse driving condition that could result from adverse weather conditions, excessive driving speeds, or rapid deceleration that can be caused by application of the brakes or by a collision. It should be pointed out that the colors provided in the table are merely for purposes of illustration and not for purposes of limitation.

Similarly, in the same way in which the length of time that the accelerator light stays illuminated or flashed during poor weather conditions, such embodiment can also be useful during a hard braking scenario. A hard braking scenario can be based upon the degree of deceleration or the pressure applied to the brake can communicate a signal to an accelerator indicator to communicate the relative degree deceleration to following cars to avoid a potential collision. Like the degree of weather, the degree of braking can be based on a relative scale. For example, deceleration can be based on a scale of 0 miles per hour to 100 miles per hour. Thus, as deceleration increased, the length of time the accelerator light could be either lengthened or shortened, depending upon what a manufacturer, car owner, or government entity desired.

In another embodiment, the flashing of a vehicle's accelerator, coasting, and brake indicators depends upon the state of a vehicle's gears or gear switch. For example, when a vehicle is in park, a vehicle's accelerator indicators no longer respond to use of the vehicle's accelerator, and brake indicators are dimly or brightly lit. In another example, when a vehicle is in reverse, a vehicle's accelerator indicators are dimly lit, or brightly lit. In a further example, when a vehicle is in reverse, a vehicle's brake indicators are dimly lit, or brightly lit. In another example, an accelerator indicator is illuminated at one level while the vehicle is in one gear and illuminated at a second level while the vehicle is in another gear.

The intensity of the flash can be varied during the duration of the flashing. For example, the intensity pattern can be bright, medium, or the pattern could be constant. The rate can increase or decrease based on the speed of the vehicle. For example, if a car is traveling, then the speed of the flashing could also be increased to provide that information to another driver. Finally, a pattern can be used to increase the conspicuousness of the flashing. The pattern could be evenly spaced, unevenly spaced or random. The pattern can be created by the length of time of the flash coupled with the interval of the flash. In one embodiment, different colors are spaced within the flashing pattern.

Similarly, like the accelerator indicator, the brake indicators can also have variables including, but not limited to length of flashing, interval of flashing, changing of color, and changing degree of brightness or intensity based upon deceleration or based upon the application of pressure to the brakes. The coasting and turn signal indicators can also be adjusted in a similar manner as illustrated by the table.

TABLE 3B
Changing signal indicator based upon weather and speed.

| | Weather | 0 | 1 | 2 | 3 | 4 | 5 | 6 | 7 |
|---|---|---|---|---|---|---|---|---|---|
| | Speed | 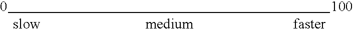 | | | | | | | |
| Signal Indicator | | | | | | | | | |
| Accelerator | length of | | * | ** | *** | **** | ***** | ****** | ******* |
| or | flashing | | | | | | | | |
| Braking | By interval of | | - | -- | --- | ---- | ----- | ------ | ------- |
| | flashing | | | | | | | | |

| | |
|---|---|
| By changing of color | 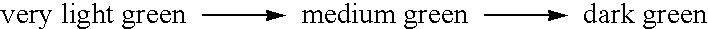 |
| By degree of brightness | 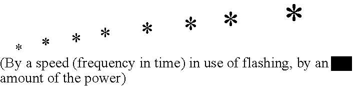 |

In one embodiment, the signaling system can be automatically triggered in adverse driving conditions, and the degree of the flashing, including the length, interval, color change, and/or brightness can be controlled by various factors including the range between a lead car and a following car, the weather condition, and/or the velocity of the vehicle.

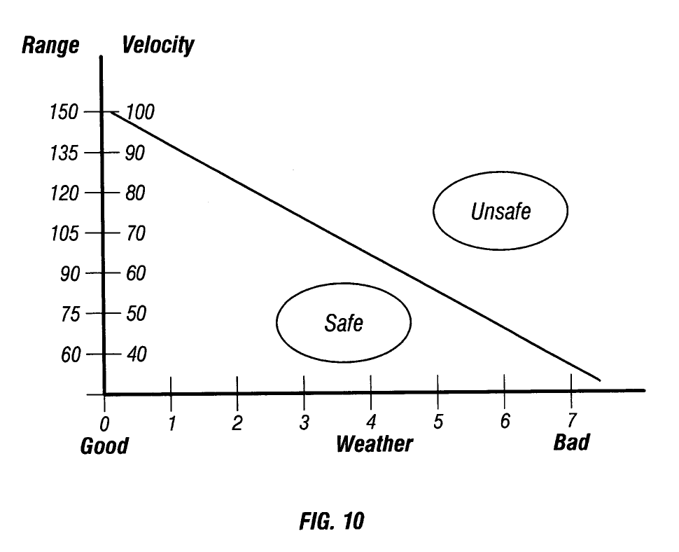

For example, referring to FIG. 10, the safety range can be dependent upon two variables—the weather and the vehicle velocity. For example, a vehicle traveling in thick fog at a high rate of speed, has a greater need of visibility than a vehicle traveling at a lower rate of speed in clearer weather conditions. Thus, as weather conditions worsen, the distance for safe driving, e.g. safe distance, between vehicles increases. The safe range between the cars can also be dependent upon speed in clear weather driving conditions, as will be discussed in more detail below with regard to the section entitled, “Embodiments for a Warning System”. The relationship depicted in the graphic representation of FIG. 10 is for illustration purposes only. The actual relationship may be non-linear and it should be noted that the numbers provided have no units and are used merely to demonstrate a general trend.

Separate dashboard indicators communicate to a vehicle operator of the state or use of improved brake, coasting, turning, and accelerator indicators. In one embodiment, on the console or dashboard of a vehicle having an improved accelerator indicator, there is an indicator showing the use of such one or more external accelerator indicators. Further, there is optionally an indicator showing the use of one or more brake indicators. Alternatively, such console indicator shows the actual state of an external accelerator indicator. Also, such console indicator may also show the actual state of an external brake indicator. A console indicator may be used to show the states of accelerator engagement, accelerator disengagement, brake disengagement, brake engagement, coasting, and turn signal use.

In summary, in adverse weather driving conditions, a two color signal indicator wherein a first color indicates a brake and a second color indicates acceleration can be used in accordance with one embodiment of the present invention. Such colors can be especially helpful in poor visibility driving conditions to easily alert other vehicle operators of the state (accelerating, braking, turning, or coasting) of a vehicle. The brake indicator can be red or some other indicator and the accelerator color can be green or blue or any other color except it cannot be the same color as the brake indicator. In such an embodiment, either the accelerator or brake indicator can also be used for a turn indicator. Each indicator can also be configured to have a first intensity and a second intensity wherein the first intensity is different from the second intensity. In such an embodiment, all indicators (brake and acceleration; side-mirror mounted, door mounted, front facing, rear facing, rear window mounted, top facing, front window mounted, etc.) can be used as emergency indicators.

In accordance with one embodiment of the present invention a three color signaling system can be used wherein a first color indicates a brake and a second color indicates acceleration and a third color indicates a turn/coasting signal. The brake indicator can be red or some other indicator and the accelerator and turn/coasting color can be green or blue or any other color except it cannot be the same color as the brake indicator. Each indicator can also be configured to have a first intensity and a second intensity wherein the first intensity is different from the second intensity. In such an embodiment, all indicators (brake, acceleration, and turn/coasting; side-mirror mounted, door mounted, front facing, rear facing, rear window mounted, top facing, front window mounted, etc.) can be used as emergency indicators. It should also be pointed out that the tables and figures are provided for purposes of illustration and not limitation. The use of flashing lights can be manually controlled or controlled through an automatic control system based on inputs from various sensors. In one embodiment, a moisture, temperature, photometer or other type of sensor is used to determine hazardous, low visibility or inclement weather conditions. For example, a weather detection device can be incorporated to trigger the adverse weather condition safety signaling package of the present invention. Such weather detection device can include a visibility detector, humidity sensor, hygrometer, thermometer, and/or sensitometer (photometer). Such sensors are electrically connected to an electronic logic component which controls the amount of flashing of all indicators. The logic component may be set so as to increase or decrease the intensity of the indicators depending on the prevailing operating conditions such as fog or rain.

Further, the change from a clear weather signaling system to an adverse weather signaling system can be made manually by an operator of the vehicle or automatically pre-programmed based upon the factors discussed above. In a further embodiment, a manual switch is also provided to the vehicle operator to select the amount of flashing of all indicators, in addition to the intensity, pattern, length, interval, and/or colors of the illuminated indicators. Such flashing of accelerator and brake indicators may be in addition to the use of traditional turn indicators, or may be used in place of traditional turn indicators in inclement weather because of the benefit of increased visibility under such conditions. Further, vehicle variables, including gear the car is in, speed of car, brake pressure, etc. can be used to change between the clear weather safety signaling system and the adverse weather safety signaling system. Further, logical control programs and managing software programs can also be implemented.

Embodiments for a Warning System

In one embodiment, a rearward-facing and/or forward-facing proximity detector is used to illuminate or flash indicators and/or sound a horn to warn an approaching vehicle and itself. The indicators may be visible from the same locations described above. Such indicators operate automatically or independently of the operator of the vehicle. For example, even if the weather conditions are good, it is important that a vehicle's visibility be increased if a collision is probable. For example, if a driver is falling asleep and his speed will cause an impact with another vehicle, then the lights of the vehicle may be altered in intensity, pace or sequence to warn the forward vehicle. The trailing vehicle may also be warned by actuating the brake lights even if the brakes are not engaged.

In another embodiment, a digital or analog device presents the distance between an object, such as another vehicle, and the front of the operating vehicle. The operator of the vehicle is then more informed as to the actual distance between the vehicle and the object. Such a distance measuring device is more accurate and provides more safety than the operator relying solely on visibility with the naked eye and mental estimation of the distance. Such increased accuracy and safety is especially important under inclement operating conditions such as, but not limited to, fog and rain.

Side, rear, top, and/or forward mounted brake indicators, turn indicators, coasting indicators, and accelerator indicators may be programmed to flash or illuminate to communicate one or more emergency states. A driver can actuate a control inside or outside a vehicle to illuminate one or a combination of brake, accelerator, coast, and/or turn indicators and/or the side, roof, and/or antenna indicators previously discussed above. A pre-programmed sequence of illumination or flashing of such lights would communicate more effectively to viewers of an emergency state. In one embodiment, brake indicators would flash or illuminate with a red hue, turn indicators would flash a yellow or amber, and accelerator indicators would flash or illuminate with a blue or green hue.

One such example of an emergency state is a potential collision. In one embodiment, the accelerator, brake, turn, or antenna indicators described above can be used alone or in combination to signal a potential collision event. Referring to FIG. 8D, a leading vehicle 834 traveling at a first velocity or speed is followed by a trailing vehicle 837 traveling at a second velocity or speed. For purposes of this example, assume both the leading vehicle and trailing vehicle are traveling at 70 miles per hour. In response to an obstacle 800 in the road, the operator of the leading vehicle 834 abruptly applies the brakes and has a concomitant reduction in speed. A negative velocity differential is thereby created between the leading vehicle 834 and the first following vehicle 837. As used herein, a velocity differential is calculated by subtracting the trailing car velocity from the leading car velocity. Therefore, a positive velocity differential indicates that the leading car is traveling at a greater velocity than the trailing car. A negative velocity differential indicates that the trailing car is traveling at a greater velocity than the leading car. A negative velocity differential is an indicator of an imminent collision or collision event. The time until collision or collision time can be calculated by dividing the distance between the leading vehicle and trailing vehicle by the velocity differential. It should be pointed out that the collision time is not necessarily constant and can fluctuate since the velocity differential is likely dynamic as a result of the braking of the leading car or vehicle. However, velocity differential averages and trends can be calculated, by for example, a microprocessor. If the driver of the trailing car 837 is distracted and fails to notice the lead car 834 ahead has begun to slow down, the chances for a collision are increased. It is common for trailing vehicles to adhere to the “3-second rule” which means that the trailing vehicle will pass the same place in the road 3 seconds after the leading vehicle. Thus, two vehicles substantially adhering to the 3 second rule will be traveling roughly 308 feet apart at 70 miles per hour (103 ft/s). Assuming an average negative velocity differential of 40 miles per hour (59 ft/s), a collision event would occur in about 5.25 seconds. It can be relatively easy for a driver of the trailing vehicle to become distracted for such a short period time. By providing a signal that indicates an imminent collision may occur unless immediate action is taken, the driver of the trailing car may be in position to respond to completely avoid a collision or to minimize damage.

Thus, one embodiment of the present invention is a method for detecting a collision event by providing a proximity detector that can calculate a distance and a velocity differential between a trailing vehicle and a leading vehicle, calculating a collision time based upon the velocity differential and distance, and providing a signal that indicates an imminent collision or collision event based upon the collision time. It should be pointed out that the instant invention is not limited to a leading vehicle and a trailing vehicle and the instant invention should be construed to encompass potential collisions such as side-collisions that can occur for example at an intersection and head-on collisions.

A proximity detector, such as a radar or laser radar device can be used. Proximity detectors similar to those used in adaptive cruise control can be used in the instant invention. Further, the following patents disclose proximity detectors that may be useful in the present invention: U.S. Pat. No. 5,757,308 to Lissel et al.; U.S. Pat. No. 5,633,705 to Asayama; U.S. Pat. No. 5,510,990 to Hibino et al.; and U.S. Pat. No. 4,948,246 to Shigematsu. A proximity detector can be mounted to the front, side, and/or rear of a vehicle. Placement on the front of a vehicle permits a collision event to be detected by a trailing vehicle 837 whereas placement on the rear of a vehicle permits a collision event to be detected by a leading a vehicle 834. For example, if the collision event is detected by a leading vehicle 834, e.g. if the proximity detector is rear-mounted, a signal can be sent to the rearward facing brake indicators 357 mounted on the lead vehicle 834 and/or to other indicators including the side-mirror mounted indicator 315, and/or door mounted indicator 333, and/or the rear window mounted indicator 364, and/or to a front or rear mounted horn, to warn the trailing vehicle of an imminent collision so that the trailing vehicle 837 can take preventive measures. In addition, a signal light, flashing light, and/or sound can also be sent to an indicator on the dashboard of the leading vehicle 834 to warn the driver of an imminent rear end collision. In one embodiment, a signal is sent to a rear-mounted horn that sounds from leading vehicle 834.

Alternatively, if the collision event is detected by a trailing vehicle 837, e.g. if the proximity detector is front-mounted, a signal can be sent so as to trigger the horn of the trailing vehicle to alert the operator of the trailing vehicle of an imminent collision so that the operator of the trailing vehicle can take preventive measures. Such audio cue may be especially helpful to alert a distracted operator, who may be dialing a cell phone, staring in the rear view mirror while yelling at misbehaving children, or adjusting the radio and/or CD changer. A signal can be sent to the headlights of the trailing vehicle 837 to flash indicating to the lead vehicle 834 that a collision is imminent and to brace for impact. A signal can send a warning light emitted in a trailing vehicle 837 interior. In one embodiment, the warning light comprises the flashing of at least one of the interior lights. Such embodiment may be especially beneficial at night and such embodiment also illustrates that the invention can be used not only to avoid a collision between a leading and trailing car, but to avoid any type of collisions that can be caused, for example by a sleepy driver careening towards a divided highway barrier.

It should be noted that the same indicator configurations that are discussed above regarding the various intensities, durations, colors, and patterns that can be used in relation to braking, accelerating, coasting, and/or turn indicators can also be used as a signal that indicates a collision event based upon a calculated collision time. Additionally, the headlights can also be configured to signal a collision event in the same manner as the indicator lights.

The present invention permits an operator to have several options regarding the signal indicating the collision event. In one embodiment, the operator can manually adjust the sound from a variety of warning sounds. In one embodiment, the operator can adjust the internal and external indicators independently. In one embodiment, the operator can disengage or mute the signal. Such an embodiment may be desirable if the trailing vehicle operator is alerted of a possible collision event, but wishes to ease off the accelerator rather than pushing the brakes, or realizes that such event is temporary in light of a pending lane change. Such scenario can occur when a trailing vehicle purposely rapidly approaches a leading vehicle.

In one embodiment, the safety signaling system can be triggered anytime the safety zone D between two cars is violated. In one embodiment, if the safety zone D is violated, the lead car indicator lights comprises illuminated red lights and the following car indicator lights comprises brake lights. Such embodiment may be desirable when a following car is slowly approaching a lead car in clear weather. In one embodiment, if a following car is slowly approaching the lead car in adverse weather, the lead car indicator lights comprises flashing red lights. In an alternative embodiment, if the safety zone D is violated, the lead car indicator lights comprise flashing brake lights at a first or second intensity and the following car coasting lights comprises flashing yellow lights at a first or second intensity. Such embodiment may be desirable in a scenario when the following car is quickly approaching the lead car in clear or adverse weather.

In one embodiment, when a following car is within the safety zone of a lead car for an extended period of time, the signaling system can change. For example, the brake lights on the lead car may turn off, or the brake lights may intermittently turn on over longer periods of time.

In one embodiment, the pattern of the signal can be operator/driver controlled. In an alternative embodiment, the pattern of the signal can be automatic. In one embodiment, the duration of the signal can be operator/driver controlled. In an alternative embodiment the duration of the signal can be automatic. Such varying embodiments can be desired and/or employed depending upon attitudes regarding driving events such as tailgating. For example, a leading vehicle may wish to signal to a tailgater that the tailgater is traveling too close by, for example, illuminating the brake lights on the lead vehicle when a collision time is less than 5 seconds. The brake lights can then stay on for a pre-determined amount of time, such as 30 seconds, until the lead vehicle operator turns off the brake lights, or until a positive velocity differential is established for a pre-determined amount of time. Additionally, an audio cue such as a horn sounding may be added to the visual brake light cue if the collision time becomes less than 3 seconds and the audio cue can stay on for a pre-determined amount of time, until the lead vehicle operator turns it off, or until a positive velocity differential is established for a pre-determined amount of time. The numbers in the above examples are clearly given for solely purposes of illustration and not limitation and should not be construed to limit the patent to such numbers.

Like the signal duration, the collision time can be operator/driver controlled or automatic. In one embodiment, a stepped collision time can be used. For example, when the collision time is equal to or greater than 6 seconds (slow approach), a first signal can be sent that turns on the brake lights, when the collision time is between 5 and 6 seconds (fast approach), a second signal can be sent that causes the brake lights to flash, and when the collision time is less than 5 seconds (faster approach) an audio cue, such as the horn sounding, can be employed. The numbers in the above examples are clearly given for solely purposes of illustration and not limitation and should not be construed to limit the patent to such numbers.

Separate dashboard indicators communicate to a vehicle operator of the state or use of improved brake, coasting, turning, and accelerator indicators. In one embodiment, on the console or dashboard of a vehicle having an improved accelerator indicator, there is an indicator showing the use of such one or more external accelerator indicators. Further, there is optionally an indicator showing the use of one or more brake indicators. Alternatively, such console indicator shows the actual state of an external accelerator indicator. Also, such console indicator may also show the actual state of an external brake, coasting, or turn indicator. A dashboard indicator may be used to show the states of accelerator engagement, accelerator disengagement, brake disengagement, brake engagement, turn signal, and coasting use. A dashboard indicator can be used to show the distance to the obstacle and/or the estimated time to impact.

In one embodiment, a sound inside the vehicle can be emitted to communicate to a vehicle operator of the state or use of improved brake, coasting, turning, and accelerator indicators, and/or a potential collision event. The sounds can include a human voice talking or singing. A voice may say the words “Stop! Stop! Stop!” if the vehicle is braking. Sounds can also include, but are not limited animal sounds, musical sounds, animal sounds, and natural sounds such waves on a beach.

Table 5A depicts several examples of a sound warning configuration that can emanated by audio cues in accordance with various embodiments of the present invention. Such examples are provided for purposes of illustration and not limitation. As shown by Table 5A, in one embodiment, the length and/or volume of the sound can be dependent upon the collision time and/or the distance between a leading and following vehicle. In one embodiment, the audio cue is triggered after a following vehicle has entered the safety zone of a leading vehicle. Such embodiment can be particularly useful if the distance, collision time and/or velocity differential between the leading vehicle and following vehicle is below a certain threshold. For example, in one embodiment, one the following vehicle enters the safety zone, a sound cue is initiated in the interior of the leading vehicle and as the following vehicle gets closer to the lead vehicle, the volume of the sound cue increases. In one embodiment, as the following vehicle gets closer to the lead vehicle, the length of the sound increases. Thus, as shown in Table 5A, at a distance of 500 feet, a relatively lower volume audio cue will be sounded than would be sounded at a distance of 10 feet. Similarly, at a potential collision time of 7 seconds, a relatively lower volume audio cue will be sounded than would be sounded at a collision time of 1 second.

TABLE 5A
Sound Warning Configurations.

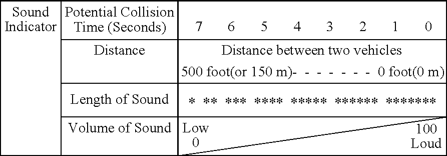

Table 5B, below, depicts an example of the types of sounds that can be used as an audio cue in accordance with various embodiments of the present invention. It should be noted that either pre-recorded sounds or sounds from a device can be used.

| Sound Style | Type of Sound | Example |
|---|---|---|
| Human Voices | Words | “Stop, Stop, Stop” “It is closing to the vehicle” |
| | Songs | “Sound of Music” “Halleluiah” etc |
| Sounds of | Animal Sounds | Wild Animals - tiger, lion, wolf, frog etc. |
| Living | | Domestic Animals - cow, house, dog, cat, goat, a pig, |
| Creatures | | rooster, cock, , a sheep etc. |
| | | Birds - sparrow, skylark, owl, cuckoo, sparrow, magpie, |
| | | drake, swallow, pheasant, bush warbler, oriole, canary, |
| | | crow (raven), crested ibis, chicken, duck, pigeon, dove, |
| | | goose, gander, starling, greenfinch etc. |
| | Insects | cicada, cricket, grasshopper, bee, a scarabaeid (beetle) |
| Machineries | Machinery sound | ding˜ ding˜ ding˜, ding dong dang, tick tack |
| | | siren, ,, hone, car, motorcycle, ship whistle, aircraft etc. |
| Natures | Nature sounds | wind, water fall, thunder, brook, |
| Music | Musical Tunes | Songs, wind orchestra, marching band, |
| | Musical Instruments | Piano, flute, cello, violin, trumpet, bell, bamboo flute, |
| | | drum, organ, harmonica, gong, xylophone, guitar, etc |

In one embodiment of the present invention, a vehicle operator has the option of using just the forward or rearward accelerator indicators, or of using all available accelerator indicators. Likewise, a vehicle operator has the option of using just the forward or rearward brake indicators, or of using all available indicators including the turn indicators and coasting indicators. In such embodiments, a switch or other device may be used to select which mode a vehicle operator wishes to use. In one embodiment, a switch on a vehicle's dashboard allows an operator to select which mode to use. In one embodiment, the switch comprises a control button to turn on or off and/or control various external indicators including rate, intensity, pattern, or color.

In another embodiment, the response of a vehicle's accelerator and brake indicators depends upon the state of a vehicle's gears or gear switch. For example, when a vehicle is in park, a vehicle's accelerator indicators no longer respond to use of the vehicle's accelerator, and brake indicators are dimly or brightly lit. In another example, when a vehicle is in reverse, a vehicle's accelerator indicators are dimly lit, or brightly lit. In a further example, when a vehicle is in reverse, a vehicle's brake indicators are dimly lit, or brightly lit. In another example, an accelerator indicator is illuminated at one level while the vehicle is in one gear and illuminated at a second level while the vehicle is in another gear.

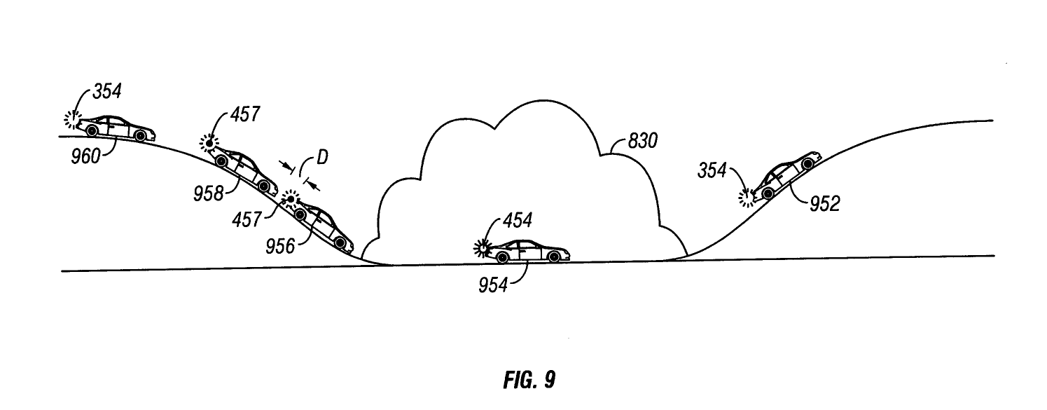

FIG. 9, a side view of cars in states of varying driving conditions, provides a summary of the invention. In accordance with one embodiment of the present invention, the safety signaling system automatically or manually can change based upon the driving conditions. FIG. 9 depicts a car 952 that has recently driven out of a valley having fog 830. Car 952 traveling outside of the fog 830 can have a first safety signaling for clear weather conditions. Such signaling systems are illustrated by Tables 1A, 2A, and 3A above. In one embodiment, the first safety signaling system can be changed, either automatically or manually, to a second safety signaling system designed for adverse driving conditions that may use flashing or strobing lights, such as depicted in Tables 1B, 2B, or 3B, to ensure greater visibility. Alternatively, a third light, antenna light, and/or changes to the intensity, pattern, and duration of the lights can be utilized in the second safety signaling system. Similarly, once car 954 has entered the foggy area 830, its safety signaling system can change, either automatically or manually, from depicted by Tables 1A-3A to one depicted by Tables 1B-3B.

Also depicted is a car 954 driving through fog 830, having a rearward facing accelerator flashing light 454 in accordance with an embodiment depicted in Table 1B. Also depicted in FIG. 9 is a leading car 956 about to enter adverse weather conditions comprising fog 830 and a trailing car 958 breaching the safety distance D and quickly approaching the behind the leading car 956, hence triggering the flashing brake indicators 457 of the lead car 956 and the following car 958. Such configuration can lead to a change in the safety signaling system in several embodiments.

In one embodiment (not shown), when the trailing car 958 has entered the safety zone D and is slowly approaching the leading car 956, a rearward facing non-flashing brake light can alert the following car 960 that a braking situation is imminent. The following car 960 which is accelerating and therefore depicting a rearward facing coasting light 354 can then ease off the accelerator or keep accelerating.

In one embodiment, if the leading car 956 abruptly applies the brakes and a negative velocity differential that exceeds a manually or automatically created collision time, the safety signaling change can occur to indicate to the trailing car 958, through a flashing brake light, audio cue such as horn sounding, etc., that the leading car 956 is braking hard and a collision may be imminent.

It should be noted that the present invention can combine features disclosed herein. For example, the clear weather embodiment and adverse weather embodiment can work together at the same time. Further, the invention should be construed to permit either a manufacturer or operator to choose between the various disclosed embodiments of the present invention. Further, the invention should provide flexibility to properly function permit operators and manufacturers to comply with various governmental regulations regarding vehicular traffic indicator systems.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

I claim:

1. A method for a changing safety signaling system for a vehicle comprising the steps of:
a) providing a first safety signaling system for a clear driving condition;
b) providing a second safety signaling system for an adverse driving condition, said second safety signaling system different from said first safety signaling system; and
c) changing said first signaling system to said second signaling system when said clear driving condition changes to an adverse driving condition.

2. The method in claim 1 wherein said adverse driving condition is selected from the group consisting of a reduced visibility condition, a negative velocity differential that exceeds a threshold, and a collision event.

3. The method in claim 1 wherein said adverse driving condition comprises a second vehicle rapidly approaching a first vehicle in clear weather conditions, wherein said first vehicle is hard braking in said clear weather conditions.

4. The method in claim 1 wherein said adverse driving condition comprises a collision event.

5. The method in claim 1 further comprising the step of:
d) changing said second signaling system to said first signaling system when said adverse driving condition changes to said clear driving condition.

6. The method of claim 1 wherein said first safety signaling system is selected from the group consisting of at least one brake light, at least one headlight, at least one accelerator light, at least one coasting light, and at least one turn light, and combinations thereof.

7. The method of claim 1 wherein said second safety signaling system is selected from the group consisting of at least one flashing brake light, at least one flashing accelerator light, at least one flashing headlight, at least one flashing coasting light, at least one flashing turn light, and combinations thereof.

8. The method of claim 1 wherein said second safety signaling system comprises a guide light.

9. The method of claim 1 wherein said second safety signaling system is selected from an audio cue consisting of a horn, and a sound within a vehicle interior.

10. The method of claim 1 wherein said second safety signaling system comprises a flashing means comprising means to alter the flashing intensity.

11. The method of claim 1 wherein said second safety signaling system comprises a flashing means comprising means to alter the flashing rate.

12. The method of claim 1 wherein said second safety signaling system comprises a flashing means comprising means to alter the flashing pattern.

13. The method of claim 1 wherein said first or said second safety signaling system comprises at least two colors.

14. The method of claim 13 wherein a first color indicates a brake indicator and a second color indicates an accelerator indicator.

15. The method of claim 13 wherein a turn indicator is depicted by said first color or said second color.

16. The method of claim 13 wherein a coasting indicator is depicted by said first color or said second color.

17. The method of claim 13 wherein a first color indicates a brake indicator and a second color indicates an accelerator indicator and a third color indicates a turn indicator.

18. The method of claim 17 wherein a coasting indicator is depicted by said first color, by said second color, or by said third color.

19. The method of claim 13 wherein a first color indicates a brake indicator and a second color indicates an accelerator indicator and a third color indicates a turn indicator and a fourth color indicates a coasting indicator.

20. The method of claim 1 wherein said safety signaling system includes a plurality of directional facing indicators, wherein said directional facing indicators is selected from the group consisting of front-facing indicators, rear-facing indicators, top-facing indicators, side-facing indicators, and combinations thereof.

21. The method of claim 1 wherein said vehicle is selected from the group consisting of aircraft, cars, motorcycles, trucks, trains, bicycles, watercraft, submarine, snowmobiles, toy vehicles, and any vehicle having a signaling system.

22. The signaling system of claim 1 wherein said first signaling system and said second signaling system can be automatically or manually controlled.

23. The signaling system of claim 1 wherein said adverse driving condition at step c) is based upon a safety zone between a first vehicle and a second vehicle, wherein said safety zone is determined based upon a vehicle speed or an adverse weather condition.

24. The method in claim 1 further comprising the step of:
d) providing a plurality of indicators on a dashboard, wherein said indicators communicate information regarding said signaling system and/or said driving condition.

25. The method in claim 24 wherein said information communicated is selected from the group consisting of distance between vehicles, a first car velocity, a second car velocity, and combinations thereof.

26. The method of claim 24 wherein said indicators are selected from the group consisting of lights, flashing lights, and sounds.

27. The method of claim 1 wherein said second safety signaling system is selected form an audio cue within a vehicle interior and wherein further said signaling system stops other audio devices upon commencement of said audio cue.

28. The method in claim 1 further comprising the step of:
d) providing a plurality of indicators on a dashboard, wherein said indicators communicates information regarding a vehicle speed with an audio or visual cue.

29. A method of detecting a collision event comprising the steps of:
a) providing a proximity detector that can calculate a distance and a velocity differential between a first vehicle and a second vehicle;
b) calculating a collision time based upon said velocity differential and said distance; and
c) providing a signal that indicates a collision event based upon said collision time.

30. The method in claim 29 wherein said collision event is detected by said first vehicle.

31. The method in claim 29 wherein said collision event is detected by said second vehicle.

32. The method in claim 29 wherein said signal at step c) comprises activation of a horn or sound system on said second vehicle or said first vehicle.

33. The method in claim 29 wherein said signal at step c) comprises a warning sound emitted in a second vehicle or first vehicle interior.

34. The method in claim 29 wherein said signal at step c) comprises a warning light emitted in a second vehicle or first vehicle interior.

35. The method in claim 29 wherein said signal at step c) comprises activation of brakes indicators on said first vehicle or said second vehicle.

36. The method in claim 29 wherein said signal at step c) comprises flashing of brake indicators on said first vehicle or said second vehicle.

37. The method in claim 29 wherein said signal at step c) is provided by a visual cue on antenna on said first vehicle or said second vehicle.

38. The method in claim 29 wherein said signal at step c) comprises a first intensity at a first collision time and a second intensity at a second collision time.

39. The method in claim 29 wherein said signal at step c) occurs at a collision time wherein said collision time varies based upon a first vehicle velocity or a second vehicle velocity.

40. The method in claim 29 wherein said signal at step c) occurs when said collision time is less than a programmed time.

41. The method in claim 29 wherein said signal at step c) occurs at a collision time determined by a driver.

42. The method in claim 29 wherein said signal at step c) continues until said velocity differential is positive.

43. The method in claim 29 wherein said signal at step c) continues until said velocity differential is greater than or equal to zero for a specified amount of time.

44. The method in claim 29 wherein said signal at step c) continues until said velocity differential is greater than or equal to zero for a specified amount of time, and wherein said specified time is determined by an operator of said first or second vehicle.

45. The method in claim 29 wherein said signal at step c) can be adjusted by a driver.
